(19) United States
(12) Patent Application Publication
(10) Pub. No.: US 2026/0340041 A1
(43) Pub. Date: Oct. 29, 2026

(54) EMPATHETIC DIALOGUE GENERATION SYSTEM

(71) Applicant: Health2047, Inc., Menlo Park, CA (US)

(72) Inventors: Judy L. Barkal, Menlo Park, CA (US); Edison Ting, Celina, TX (US)

(21) Appl. No.: 19/104,106

(22) PCT Filed: Aug. 16, 2024
(86) PCT No.: PCT/US2024/042810

§ 371 Date: Feb. 14, 2025

Related U.S. Application Data
(60) Provisional application No. 63/533,647, filed on Aug. 19, 2023.
(60) Provisional application No. 63/533,645, filed on Aug. 19, 2023.
(60) Provisional application No. 63/533,644, filed on Aug. 19, 2023.
(60) Provisional application No. 63/533,643, filed on Aug. 19, 2023.
(60) Provisional application No. 63/533,641, filed on Aug. 19, 2023.
(60) Provisional application No. 63/533,640, filed on Aug. 19, 2023.
(60) Provisional application No. 63/533,639, filed on Aug. 19, 2023.

(51) Int. Cl. G06F 16/9035

(52) U.S. Cl. CPC G06F 16/9035

(57) ABSTRACT

Systems and methods for empathetic dialogue generation. An example method includes receiving a message from a user; generating a user prompt from the message; providing the user prompt to a large language model (LLM); receiving an LLM response from the large language model; generating a system prompt corresponding to the message; providing the system prompt, user prompt, or LLM response to a set of guardrail observers; receiving from the guardrail observers one or more adjustments; generating a reply with an adjustment of the one or more adjustments.

### CROSS-REFERENCE TO RELATED APPLICATIONS

This application claims priority to U.S. Prov. Patent App. No. 63/533,639; U.S. Prov. Patent App. No. 63/533,640; U.S. Prov. Patent App. No. 63/533,641; U.S. Prov. Patent App. No. 63/533,643; U.S. Prov. Patent App. No. 63/533,644; U.S. Prov. Patent App. No. 63/533,645; U.S. Prov. Patent App. No. 63/533,647. Each of the above-recited applications is hereby incorporated herein by reference in its entirety.

### TECHNICAL FIELD

The disclosed technology generally relates to generating empathetic dialogue. More particularly, embodiments relate to use multiple large language models as observer guardrails to generate empathetic dialogue.

### BACKGROUND

Numerous cases exist in which people can benefit from having guidance or companionship, especially people with mental or physical conditions which require regular attention to properly manage. However, many people also have living situations in which either do not encourage or do not support frequent human contact, whether due to lack of physical proximity or limited funds to afford regular visits with health professionals who have limited availability.

Such persons may benefit from routine interactions. At present, technological techniques to enable such routine interactions are deficient. For example, current software-based conversational techniques do not enable such guidance and companionship. Thus, the current software-based conversational techniques are ill-suited to addressing this technical problem.

### SUMMARY

Particular embodiments of the subject matter described in this specification can be implemented so as to realize one or more of the following advantages. Utilizing the techniques described herein, conversations between users, such as patients of a health professional, and a system described herein (e.g., the empathetic dialogue generation system 100) may be assured to adhere to multiple complementary conversational considerations. For example, the system may generate conversational replies which monitor for harmful content, user goals, and contextual information. As will be described, a primary large language model (LLM) may be used to communicate with an end-user. For example, the primary LLM may be implemented by an outside system which responds to application programming interface (API) calls. To ensure that the conversational considerations are taken into account, the communications with the end-user may be adjusted using a multitude of LLMs, with each of the LLMs accounting for one conversational aspect. Advantageously, in some embodiments the multitude of LLMs may be run by the system. Thus, the system can enhance the primary LLM's sensitivity and applicability to the end-user. While reference herein is made to LLMs, in some embodiments Large Multimodal Models (LMMs) may be used such that the models may output text, images, audio, and so on.

As known by those skilled in the art, LLMs are increasingly being used to communicate with users while addressing requests and/or questions from the users. For example, a user may ask an LLM for a recipe which uses a list of ingredients. As another example, a user may ask an LLM to solve a particular programming problem. As another example, a user may ask an LLM to draft a poem or portion of a paper based on information input by the user.

At present, however, these LLMs are ill suited for sensitive communications with users who may benefit from periodic conversations which are delivered with empathetic dialogue optionally along with images, sound, and other types of media/expressions to help facilitate engagement. For example, a health professional (e.g., a mental health specialist) may advise a patient to engage in routine communications with friends or family. For certain patients, however, they may lack friends or family, or they may be uncomfortable communicating with friends or family about mental health issues. The above-described patient may turn to existing LLMs; however, existing LLMs suffer numerous technological defects which make them problematic for such a use case.

As an example, an LLM at present is difficult to constrain. Current techniques include a complex prompt which is provided with any interaction with a user 108. The complex prompt may outline the role of the LLM (e.g., helper) and may try to introduce safeguards. As known by those skilled in the art, these safeguards are easily broken due to actions of the user or malicious actions by others (c.g., prompt injection attacks). There is also no guarantee that such safeguards are maintained during a conversation. Thus, for sensitive conversational applications, such as trying to introduce routine empathetic dialogue into the user's life, the LLM is not a reasonable technological solution.

Furthermore, the health professional may prefer to have the conversations with the user to be geared towards certain goals. As one example, the health professional may prefer that the user be nudged towards social interactions in the real world. As another example, the health professional may prefer that the user receive encouragement to follow the health professional's nutritional advice. As another example, the health professional may prefer that the user be periodically reminded to take his/her medicine. At present there is no technique by which an LLM, which is largely a black box, can guide the user toward the goals.

Thus, while an LLM provides substantial technical benefit in certain areas, for interactions that rely upon empathetic dialogue they introduce substantial technological problems. As will be described, the techniques described herein utilize additional LLMs, and other techniques, as guardrails. These additional LLMs are described herein as guardrail observers. For example, the guardrail observers may monitor communications with a primary LLM and adjust, or otherwise update, the communications. As one example, the guardrail observers may include information in a prompt (e.g., a message) to the primary LLM to segue to a different topic. As another example, the guardrail observers may include information in a prompt to the primary LLM to introduce a particular topic. Additional examples may include adjusting prompts to introduce goals, to recall information or stories of interest to the user, and so on. Similarly, the guardrail observers may adjust, or even block, a message being provided by the primary LLM to the user. For example, a guardrail observer may remove reference to political discussion, or other topics known to be problematic to the user (e.g., based on a history of conversations with the user).

Example guardrail observers may include a watcher, reasoner, and planner. These guardrail observers will be described in more detail below. As an overview, the watcher may help to guide conversations between the user and the system to avoid, or otherwise mitigate, harmful content. For example, the watcher may cause a message from the user to be disregarded, or otherwise altered, and cause the primary LLM to change topics. As another example, the watcher may similarly disregard, or otherwise alter, a message from the primary LLM and cause it to generate a new message which changes topics.

The reasoner may have access to a conversational history. or features extracted from the conversational history (e.g., preferences, likes, interests, dislikes). As will be described, the reasoner may look for times at which it can inject message or prompts. For example, the reasoner may have access to goals set by a health professional or the user. In this example, the reasoner may monitor a conversation and identify when the add a message which is geared towards furtherance of a goal. As will be described, the reasoner may adjust a prompt which is being provided to the primary LLM. For example, the reasoner may add language to a message received from the user which informs the primary LLM that it should reference, or otherwise further, a particular goal. Thus, the output of the primary LLM, which may also be analyzed by the reasoner, may cause introduction of the particular goal.

The planner may analyze a current conversation with a user and look for potential segues. The segues may be used to provide real-time segues towards particular goals. As an example, the user may be communicating with the system about an upcoming trip to a particular country. The system may have knowledge, for example based on the current or prior conversation(s), that the user enjoys trying new foods. Thus, the planner may determine to segue into a discussion about healthy eating while trying new foods on a trip.

The coordination of the above-described guardrails may be performed by the system. As an example, the system may determine whether to adjust a conversation with a user based on the output from the guardrail observers. For example, the system may determine to ignore the guardrail observers or may determine to implement one of the adjustments from one of the guardrail observers. Additional description regarding coordination, and use of the guardrail observers, is included below with respect to at least FIGS. 1B-1C.

As will be described in FIG. 1A, a user can interact with a user device to provide a message to the system, either spoken or provided via input of text. The system may receive the message and, and as described above, determine whether to the adjust the message prior to transmission to an outside LLM (e.g., the above-described primary LLM). The outside LLM may thus respond to the received message, with the response being routed to the system described herein. Similar to the above, the system may determine whether to adjust the received message prior to transmission to the user device.

In an effort to increase conversational ease and enhance the empathetic nature of the conversation, the system may render an avatar on the user device to speak, or otherwise output, the messages being provided to the user device. As will be described, the avatar may be user 108 selectable (e.g., in FIG. 1A, a cat is selected). The avatar may be rendered in realistic motion, for example using machine learning techniques, such that the user may communicate with the avatar while the complex back-end processing described herein is masked from his/her view.

As will be discussed in FIG. 1B, the system can additionally implement the above-described guardrail observers. Guardrail observers can include one or more additional LLMs with sets of conditions and instructions which, when a message is received, cause the LLMs to generate response adjustments, composed of responses generated by one or more LLMs which can supplement or replace a response generated by the external LLM. Furthermore, the system can include dialogue history, a record of received messages and generated replies; world context, a database including information on a host of topics, both plainly relevant to a user's living situation and personal circumstances, and those tangentially related; a user model, which can include descriptions and factors concerning user's physical and mental condition and potential ailments as well as health and personal goals the user has been prescribed and sought out themself; and a configuration, which can include personal preferences of a user.

As will be discussed in FIG. 1C, the guardrail observers can include a planner, reasoner, and watcher. As described above, these observers may use individual LLMs with specialized conditions and instructions for generating response adjustments after a message from the user is received. The watcher can be configured to review the message for harmful content and ignore the harmful content when generating an adjustment. Harmful content can be inflammatory or controversial topics which are likely to cause distress in a user if mentioned in conversation. The planner can be configured to review the user prompt and dialogue history to generate response adjustments including conversation segues which introduce into a conversation advice or a recommendation which can lead a user to take actions to achieve one or more goals. The reasoner can review one or more databases to find contextual information to generate a response adjustment which include the contextual information. The contextual information can be situational factors that are broadly applicable to persons in the position of the user. For example, contextual information can include factors common to a user's housing situation, climate, and geographical location. For each of the guardrail observers, if relevant information is not identified, a response adjustment will not be generated.

As is further described in FIG. 1C, each response adjustment can be received by a queue, a data structure which stores response adjustments and provides them to a resolver. The resolver may select a response adjustment based on one or more factors. In some embodiments, the factors can be an inherent priority wherein a response adjustment from a watcher has highest priority, followed by the planner and then the reasoner. When a response adjustment is selected by the system (e.g., by a dialogue generator of the system), a response may be obtained. For example, the response may be from the external LLM in response to the response adjustment. As another example, the response may reflect output from the external LLM as adjusted according to the response adjustment. The response can be converted into a text message and provided to the text-to-speech module, wherein a corresponding audible and/or visual reply can be generated and presented to a user.

Applying the aforementioned methods and system can allow conversation with a user which accounts for a user's sensitivities, health conditions, and personal preferences, and includes replies which both provide stimulation to a user as well as offer advice and actionable steps which can be taken by a user to achieve their personal and health goals.

The system can further be configured to identify and record social determinants of health, aspects of a user's socio-economic condition which are correlated with health-related outcomes. The system can be configured to identify Social Determinants of Learning (e.g., physical health, psychosocial health, physical environment, social environment, economic stability and self-motivation).

The system can be manually modified by a health professional so as to supply corrections to one or more generated replies and direct future replies to be generated in a manner which accommodates the corrections. Example description regarding modification, or other control, of the system is included below with respect to mentor mode.

The empathetic dialogue generation system can also include a turn tracking module which identifies topics of conversation and prevents the topics from being reintroduced into a future reply until a sufficient amount of time has passed and/or a sufficient number of replies have been generated.

The empathetic dialogue generation system can further be configured to monitor a user's mood, identify when a user is experiencing a negative mood, and generate one or more replies and images intended to improve the user's mood.

To complement the empathetic dialogue generation system, an avatar generation system can be implemented to receive or create images of persons, animals, or objects, which are then animated so as to imitate movement which matches audible replies.

In some embodiments a method, and system or computer storage media implementing the method, are described. The method includes accessing a message which forms part of a conversation history with an end-user, wherein the system maintains communications between the end-user and an outside large language model (LLM) being executed by an outside system, wherein the conversation history reflects messages being provided between the end-user and the outside LLM, and wherein the message was received from the end-user for routing to the outside LLM; determining an adjustment to the message based on a plurality of guardrail observers, wherein individual guardrail observers reflect individual LLMs which are executed by the system, wherein the guardrail observers adjust messages based on individual conversational characteristics, and wherein a first guardrail observer adjusts messages based on an individual conversational characteristic that identifies segues in which the first guardrail observer can identify a particular goal set by a domain expert associated with the end-user; obtaining a response from the outside LLM based on the adjusted message, wherein the response is output via an avatar presented on a user device of the end-user.

In some embodiments, a method, and system or computer storage media implementing the method are described. The method includes implementing a plurality of guardrail observers, each guardrail observer being associated with a locally executed large language model (LLM), wherein each LLM has a system prompt defining its role; receiving a portion of a conversation history between an external LLM and a user, wherein the guardrail observers generate respective output based on the portion; adjusting a message to one of the external LLM or the user based on the output.

In some embodiments, a method, and system or computer storage media implementing the method are described. The method includes rendering an avatar, wherein the avatar outputs messages received from a system; transmitting a message from a user of the user device to the system, wherein the system adjusts the message based on a plurality of guardrail observers, and wherein the adjusted message is transmitted to an external large language model (LLM); and updating the rendered avatar to output a response from the external LLM.

### BRIEF DESCRIPTION OF THE DRAWINGS

The present disclosure is described with reference to the accompanying drawings, in which like reference characters reference like elements, and wherein:

FIG. 1A is a block diagram of an example empathetic dialogue generation system in communication with a user device.

FIG. 1B is a detailed block diagram of the example empathetic dialogue generation system.

FIG. 1C is a block diagram illustrating an example architecture and functioning of guardrail observers included in the example empathetic dialogue generation system.

FIG. 1D is a block diagram illustrating an example architecture and functioning of the empathetic dialogue generation system integrating with one or more health device 152s and receiving and integrating health data from a health data store.

FIG. 2 is a block diagram illustrating an example architecture and functioning of the avatar generation system.

FIG. 3A-B are block diagrams describing a method of generating emphatic conversations with a user.

FIG. 4 is a block diagram illustrating an example implementation of a topic transition structure.

FIG. 5 is a block diagram illustrating a method of employing the mentor mode.

FIG. 6 is a block diagram illustrating an example embodiment of the method of monitoring and responding to a user's level of engagement.

FIG. 7A is a block diagram illustrating an example method of categorizing health related information from user messages and presenting the information to mentors.

FIGS. 7B and 7C are example user interfaces that include summarizations of observed messages including information relating to health states and/or conditions as displayed within mentor mode.

FIG. 7D is an example user interface describing the system performing topic transition structure analysis during the follow-up step.

### DETAILED DESCRIPTION

This application describes techniques and methods to direct generation of empathetic dialogue from a large language model (“LLM”) to account for sensitive conversational topics, user goals, and broad contextual conversational backgrounds (e.g., multi-lingual functionality). As will be described, a system described herein (e.g., the empathetic dialogue generation system 100) may address technological shortcomings associated with LLMs to enable such generation of empathetic dialogue. While reference herein is made to LLMs, in some embodiments large multimodal models (LMMs) may be used. Additionally, reference herein is made to health professionals. In some embodiments, other domain experts, such as education professionals, may leverage the disclosed technology.

### Introduction—LLM Background

As known by those skilled in the art, an LLM is a type of generative machine learning (“ML”) technique designed to process and generate human-like text and which is trained based on vast amounts of textual data. LLMs can utilize deep learning techniques, particularly variants of neural networks, to understand and produce language with a high degree of accuracy and contextuality. As an example, an LLM may leverage an attention-based layers, optionally using a mixture of experts architecture. For example, in one application, an LLM may be used as a conversational tool such that a user can engage in a simulated conversation with an LLM by sending messages (either text messages or spoken speech converted into text messages) to the LLM and receiving replies which account for context of messages and include words and phrases statistically likely to be appropriate and relevant. LLM technology can be so robust as to enable directed prompts, where replies can be focused by providing instructions within prompts. For example, an LLM can be provided the following user prompt, “Analyze the following sentences and summarize their contents,” followed by a series of sentences to be analyzed. In this example, the LLM can be effectively directed to analyze the provided texts. Providing properly phrased instructions can allow tailoring of replies according to needs of a user.

As an example, and without by constrained by way of theory, LLMs function by being trained on large quantities of text and developing probabilistic models that can predict which sequences of words are likely to be associated in regular communication. Upon receiving a prompt of one or more words, an LLM can iteratively select words to form a reply. Iterations may cease when the LLM determines a probability of a reply being complete is sufficiently high. How the probabilistic models are designed and how they function is dependent upon architecture of a specific probabilistic model being applied. Each word and symbol in a prompt reflect an added piece of probabilistic context which is considered by a model, but because replies are based on probabilities, generated replies may not include or reference all context included in a prompt.

As a number of words and symbols which are included in a prompt increase, a probability that individual words, phrases, or symbols will significantly influence a corresponding reply decreases. Specifically, prompts including a large number of words and symbols can include words or symbols which are not reflected in (or significantly influential on) generated replies. For example, a first prompt of “What day of the week is it?” can cause generation of a reply “Today is Monday”, whereas a second prompt of “I am wondering about how safe waterskiing is and what time of the day is best suited for water sports” can cause generation of a reply “Between three o'clock and five o'clock is the best time for water sports due to the increased air temperature.” In the first prompt, there were relatively few words from which to draw context, so the reply was highly specific and focused. In the second prompt, multiple topics were mentioned—relevant to safety concerns about waterskiing and an optimal time of day to participate in waterskiing—, causing a diluting effect for each individual term in the prompt which manifested as the reply failing to include reference to safety levels of waterskiing. When the effects of dilution are applied to prompts which include instructions for analyzing text, a single LLM is limited in how effectively multiple sets of instructions can be applied simultaneously.

LLMs can be further limited in their ability to draw upon context which is not immediately present within a prompt or a previous prompt. As LLMs function by applying probabilistic models, if context of previously communicated prompts is not included in a current prompt, the previously communicated context will likely not be included in a reply. While for questions and requests which are not significantly context sensitive there might not be an issue, for questions and requests which are context sensitive, including such context can be necessary to generate properly applicable replies. Some LLMs can address this issue by including a record of previous prompts and replies and adding relevant context to new prompts (such as by adding instructions to additionally analyze the record), allowing the probabilistic models to account for previous context.

However, such a solution can still suffer from effects of dilution, wherein when a number of previous prompts and replies becomes sufficiently large, relevant context can become so limited in quantity that an LLM can effectively fail to take note of the relevant context. For example, if a user interacts with an LLM using a prompt of, “My birthday is today, what should I do?” the LLM can respond with a prompt of “Happy birthday, you should call your mother” and can utilize the prompt and reply in future replies, but there is no memory of when the user's birthday is, merely an effect on a probabilistic model. Thus, as the LLM is not actually “remembering” the user's birthday and instead is altering future prompts to account from context gathered from prompts and replies, if a few days later the LLM receives a prompt of “When is my birthday?”, the model may fail to generate an appropriate response. Furthermore, if, after receiving the initial birthday prompt and generating the reply, other prompts are received in which the term “birthday” is mentioned a sufficient number of times in different contexts—perhaps with regards to other persons' birthdays—the LLM can functionally “forget” when the user's birthday is and generate prompts which assume the only relevant birthday belongs to a friend or other mentioned acquaintance.

Thus, LLMs have limited ability to functionally remember relevant aspects of a user. This limitation can be especially relevant if a user wishes to engage with an LLM in a manner which facilitates reminders and suggestions of desired activities or other goals. Just as a user can set an alarm on a clock as a reminder to engage in an action, the user may desire conversation with an LLM to periodically reference broader goals external to context immediately expressed in recent prompts. For example, a user who is diabetic may desire for an LLM to only recommend food suggestions which are low in sugar or may desire periodic reminders to check blood sugar levels—potentially ignoring or deemphasizing context of a user's prompt in order to appeal to such goals. However, current LLM technology is limited in its ability to track or implement such goals due to limitations in preserving and accessing goals and requests in a manner which can effectively influence prompt generation.

LLMs can additionally have difficulty generating replies which account for sensitivity or empathy. As replies generated by LLMs are dependent upon probabilistic models, if training data used to generate an LLM includes harsh, vulgar, offensive, or other phrases likely to cause aggravation if seen or heard by a user, then replies generated for a user are likely to include such offensive material. This issue can be addressed by “flagging” (e.g., marking) certain words or phrases as offensive and inappropriate, but tone itself can be seen as jarring or aggravating even if explicit words are not obviously so. For example, a user can create a prompt of, “I am feeling sick today. What should I do?” to which an unempathetic reply can be “You should toughen up.” In this example, although the individual words of the reply are not strongly suggestive of rudeness or abrasiveness, when put together the reply can be received by a user as rude and unempathetic.

Furthermore, LLMs can be limited by context included in prompts and training data and unable to generate replies which fully integrate all potentially relevant context. For example, an LLM can be trained on training data which does not include any facts relevant to farming or life in farming communities and similarly the LLM (once trained) can receive prompts which do not include significant words or phrases related to farming or life in farming communities. In this example, a user who sends the LLM a prompt “I live on a farm, what should I do with my free time?” can receive a reply “Free time is a great opportunity to develop your skills and interests” or other similar replies which fail to account for context of a person living in a farming community and who engages in regular farming. Even if a user supplies prompts which include relevant context which potentially could be used to generate appropriate replies, such prompts are unlikely to include context in a sufficient quantity to allow generation of replies which include an optimal amount of context.

### Introduction-Overview

To address these limitations, the disclosed technology includes one or more externally implemented LLMs to be supported by guardrail observers which, in some embodiments, are internal to the system (e.g., the empathetic dialogue generation system 100). Each of the guardrail observers may be implemented, at least in part, by an LLM which may be executed by the system. As will be described, there may be at least three guardrail observers each performing a task for supporting generation of effective and appropriate replies. The system may use the guardrail observers to effectively generate empathetic, relevant, and appropriate dialogue which is tailored to a user's individual needs and goals. While reference herein is made to three guardrail observers being implemented by three LLMs, in some embodiments there may be 1, 2, 4, 5 LLMs and so on. For example, one LLM may perform the functionality of two or more guardrail observers.

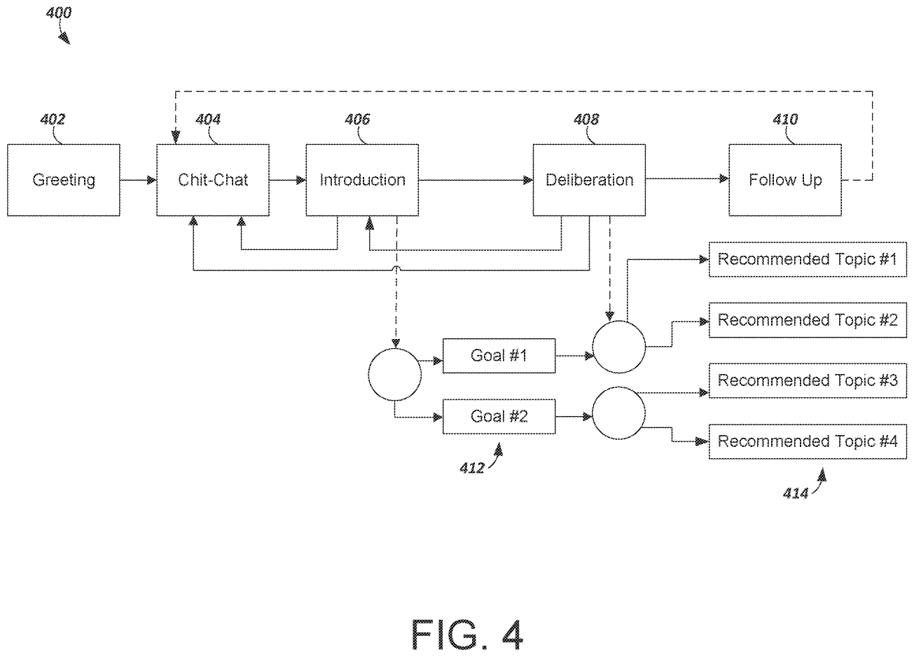

As will be described, the system can direct, or otherwise control, generation of LLM responses from an externally located LLM system and supplement, or otherwise change, the LLM responses with adjustments generated from the guardrail observers. Application of the system can cause generation of replies to user messages which account for harmful and offensive content, user goals, and broader situational context. The system, in some embodiments, is guided to achieve these functions based on a topic transition structure which includes a set of prompts to guide generation of LLM replies and adjustments. As an example overview, the topic transition structure may enable the system to transition between initial chit-chat to more empathetic discussion with a user which may guide the user towards specific goals (e.g., goals set by a domain expert, such as a health professional). Example description of the topic transition structure is included below, with respect to FIG. 4. Furthermore, the system can monitor a conversation (e.g., the user messages) to generate a theory of mind of the user, enabling a modeling of the user's mood and emotional state.

In some embodiments, the system can generate, or cause generation of, an animated avatar which visually mimics an audible reply. For example, a message from a user can be an audible question, “I'm feeling tired, what should I do to feel better?” and an audible reply can be “Taking a nap can be a great way to feel more refreshed.” The avatar can be rendered to mimic movement which emulates speaking the reply.

Operation of the system may rely on a foundation of LLM operation and direction. By applying specific prompts to an external LLM—either by supplementing user prompts provided by the user to the system or provided discretely to the system—the system can direct the external LLM to perform analytical operations which achieve complex functionality. The analysis performed by the system, such as through use of guardrail observers and associated LLMs, can include determining a user's mental/emotional state, determining if a topic transition is appropriate, determining additional context for a user message by searching a database, identifying sensitive topics mentioned in messages or LLM responses, identifying segues to introduce user goals, among other operations.

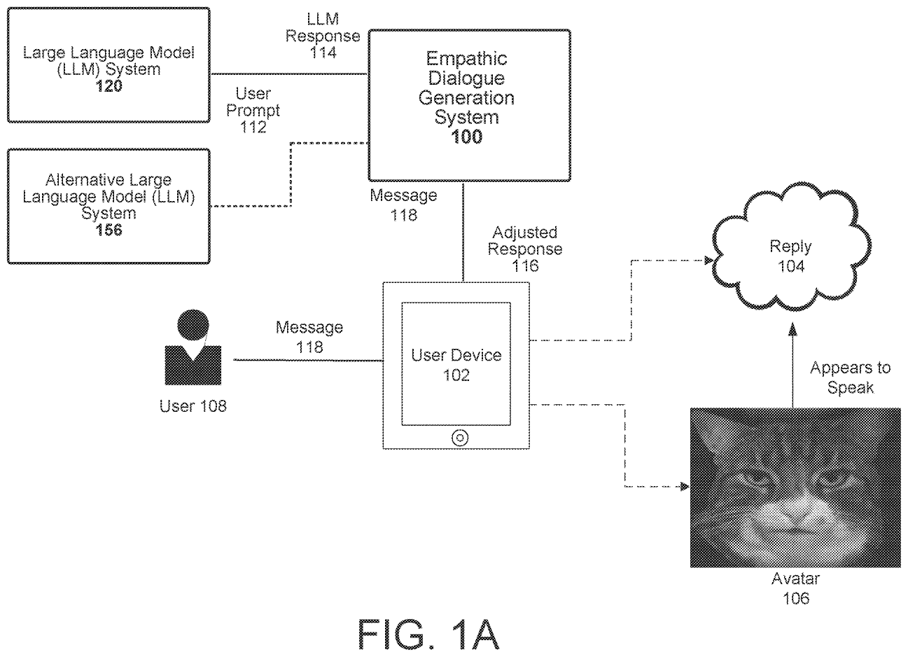

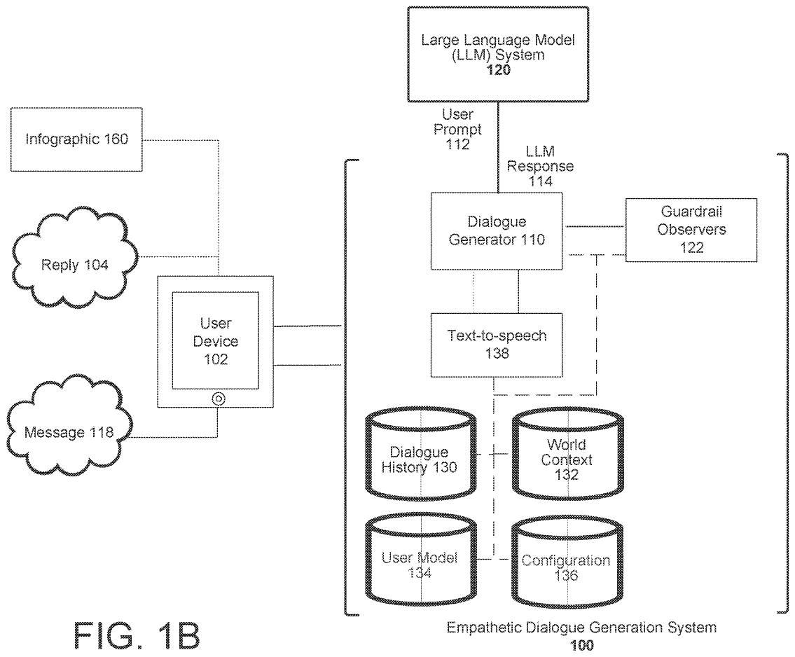

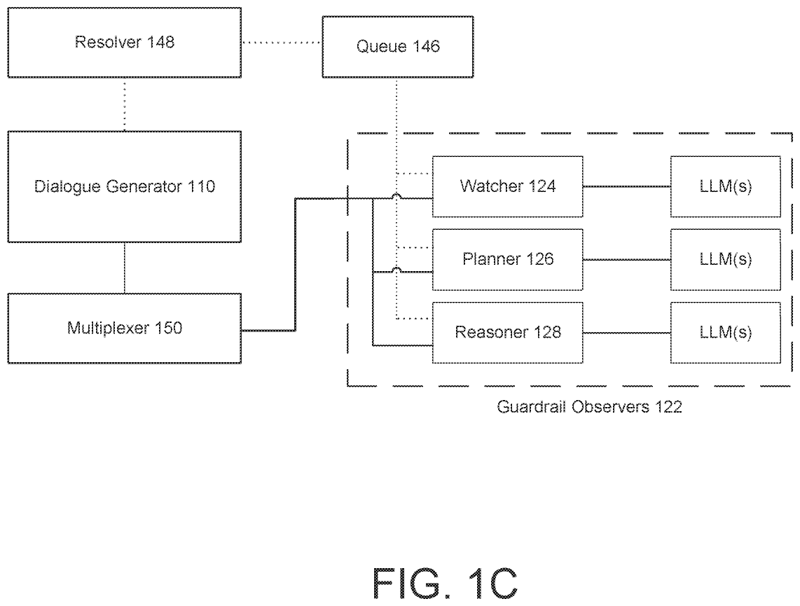

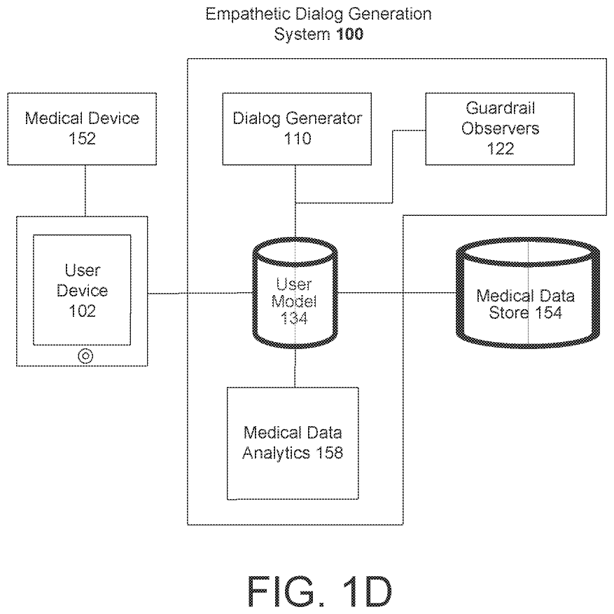

FIG. 1A is a block diagram illustrating an example empathetic dialogue generation system 100 (“system”) generating empathetic dialogue based on use of an external LLM system 120 to generate replies 104. As will be described, in some embodiments, the empathetic dialogue generation system 100 can generate, or otherwise cause rendering of, an avatar 106 to mimic recitation of the generated replies 104. As illustrated, the empathetic dialogue generation system 100 may receive a message 118 from a user 108 of a user device 102 (e.g., a mobile device, a wearable device, a computer, and so on). The message 118 can form part of a conversation between the user 108 and the system 100, and may include a question, an answer, a comment, a statement, or any combination thereof. After receiving the message 118, the user device 102 can provide the message 118 to the empathetic dialogue generation system 100 for analysis by the system 100.

As will be described, the system 100 may generate the user prompt 112 for transmission to the LLM system 120. In some embodiments, the system 100 may adjust the received message 118. For example, the system 100 may reformat the message 118 to include removal of spelling errors and grammar errors. For example, a message can be “What tim of da is it?”, wherein the letters “tim” are meant to be “time” and the letters “da” are meant to be “day.” In this example, pre-processing can include changing the message 118 to be “What time of the day is it?” In some embodiments, generating the user prompt 112 can include receiving an audible message and generating a corresponding text message with a text-to-speech module 138 (described in further detail in relation to FIG. 1B).

Generation of a user prompt 112 can further include adding one or more words or phrases to text of the message 118 to direct the outside LLM system 120 to analyze the message 118 in an intended manner. For example, the message 118 can have appended the phrase, “Analyze this message and determine the user's mental state.” In another example, the message 118 can have appended the phrase, “Analyze this and the previous ten messages to determine if the user would be receptive to suggestions concerning health-related goals.” The phrases appended to the message 118 can be referred to herein as “system prompts.” In some embodiments, system prompts can be received discretely. For example, a system prompt may be “What time is it?” In some embodiments, system prompts can be received discretely and can include references to a preceding message or proceeding user prompt 112. For example, a system prompt can be “Analyze the proceeding message for indications that the user is in an aggravated emotional state.” As will be described, the message 118 can be provided to guardrail observers (e.g., guardrail observers 122 of FIG. 1B) to cause generation of adjustments which can be used to replace or modify the messages. These adjustments may be included in the user prompt 112.

The LLM system 120 can be located external to the empathetic dialogue generation system 100 and can be interacted with by sending user prompts 112 to the LLM system 120. The LLM system 120 can be any commercially available, or open source, large language model. For example, some available LLMs include ChatGPT™, Claude™, Grok™, and so on. In some embodiments, the LLM system 120 may be interacted with using an application programming interface (API), network endpoints, and so on.

The user prompt 112 can be received by the LLM system 120 and an LLM response 114 can be correspondingly generated. Operation of the LLM system 120 is dependent upon which LLM is being used, but generally, the LLM response 114 will include a text message including words which are selected to appropriately respond or complement the received user prompt 112. The LLM response 114 can be received by the empathetic dialogue generation system 100, and the system 100 may adjust the LLM response 114 prior to transmission to, or presentation via, the user device 102. For example, and as described below, the system 100 may adjust the LLM response 114 using guardrail observers (e.g., guardrail observers 122 as illustrated in FIG. 1B).

In some embodiments, the empathetic dialogue generation system 100 can additionally interact with one or more alternative LLM systems. These alternative LLMs can similarly receive the user prompt 112 and generate respective LLM responses. Thus, the system 100 can obtain multiple responses from different LLMs. The system 100 may select from among the responses. For example, the system may prefer a response which is received first, which response is shorter or longer, a priority assigned to an LLM, which LLM best responds to the user prompt 112, and so on. With respect to the best response, the system 100 may utilize the guardrail observers (e.g., the guardrail observers 122). For example, the guardrail observers, such as the watcher, may indicate that certain of the responses include harmful content or may upset the user. As another example, the guardrail observers 122 may have adjusted the message 118 to include text indicating the LLM systems are to segue towards a goal. Thus, the guardrail observers 122 may identify that certain of the responses do not reference the goal or a segue towards the goal.

As described in more detail below, the LLM response 114 may be adjusted by the system 100 to form the adjusted response 116 via implementation of guardrail observers. As described herein, individual guardrail observers may be implemented, in part, by individual LLMs executed by the system 100 or otherwise accessible to the system 100. In some embodiments, the LLMs may represent open source or otherwise publicly accessible language models, such as Llama. For example, the LLMs may be pre-trained. In some embodiments, the system 100 may refine the weights of the LLMs through additional training. For example, the system 100 may provide additional input and expected responses for refining of the LLMs. The system 100 may compute forward passes through the LLMs or may instruct an outside system (e.g., a cloud system) to execute the LLMs.

The system may thus optionally adjust the LLM response 114 with content from one or more of the guardrail observers. The system may also route the LLM response 114 without adjustment to the user device 102. Additional description regarding guardrail observers is included below with respect to FIG. 1B.

The system may provide the adjusted response 116 to the user 108 for presentation via the user device. For example, a reply 104 to the user's 108 message may be presented as a visual text message or as audible message produced by passing the adjusted response 116.

In some embodiments, the large language model system 120 may implement a large multimodal model (LMM). In some embodiments, the guardrail observers may implement LLMs. Thus, the system 120 may output an image, audio, video, and so on in response to the user's message 118. Similarly, the user's message 118 may include an image, audio, video, and so on. As one example, the system may output an infographic (c.g., infographic 160 of FIG. 1B) which is relevant to the user's 108 message or conversation. For example, the infographic 160 may graphically describe techniques to reduce calorie consumption. As may be appreciated, the LLM system 120 may generate the infographic 160 using generative AI techniques. In some embodiments, the infographic 160 may be provided by a health professional, or other domain expert, associated with the system 100. For example, the health professional may engage in a conversation with the system 100 (e.g., in mentor mode, described below) and describe the infographic 160 and when it should be used. In some embodiments, the infographic 160 can be provided by a teacher, a counselor, a family member, or any other domain expert (e.g., a person with knowledge in a domain of interest). A domain of interest can be the field of health, mental health, nutrition, exercise science, pedagogy, amongst others. Thus, the system 100 may cause the infographic 160 to be included in the response, for example via the guardrail observers described herein.

An infographic may provide suggestions, and in some embodiments, not include advice. For example, an infographic may state or explain facts about certain benefits of exercise but may not prescribe an exercise regimen. An infographic can state “Exercise can be a good way to manage stress” but an infographic may avoid stating, “You should exercise at least 30 minutes every day.” In this way, the system 100 may provide helpful advice for the user 108.

In some embodiments, the adjusted response 116 may represent a safety message or pre-determined reply provided to the user 108. A safety message can be provided when generation of an LLM response 114 from the LLM system 120 is taking longer a threshold amount of time. The safety message may also be provided if the system 100, such as via the guardrail observers, is taking longer than a threshold amount of time to review the LLM response 114 or the system 100 is delayed or interrupted for another reason. An example safety message can be “I hear you” or “I see.” Safety messages can be included within one or more databases within the empathetic dialogue generation system 120. These safety messages may therefore further convey a realistic conversation between the system 100 and user 108, for example by masking network or other technological delay.

FIG. 1B is a detailed block diagram of the empathetic dialogue generation system 100. The empathetic dialogue generation system 100 can include a dialogue generator 110, a text-to-speech module 138, guardrail observers 122, and a set of databases including dialogue history 130, world context 132, user model 134, and configuration 136 data. As described above, a user (e.g., a patient or someone under advisement from a health professional or other domain expert), can interact with the system 100 via providing communications with the user's user device 102.

Without being constrained by way of example, the user may communicate via audibly speaking words into the user device 102 (e.g., a microphone of the device 102). The user may also provide text via interacting with an analog or digital keyboard of the user device 102. An audible message received by the user device 102 can be provided to the text-to-speech module 138 of the system 100, or processed locally on the user device 102, such that corresponding text can be generated.

The system may therefore receive a message 118 from the user device 102. (e.g., either received by a user 108 or generated from the text-to-speech module 138). As will be described, a dialogue generator 110 of the system 100 can convert the message 118 into the user prompt 112 (e.g., described in FIG. 1A) which can be provided to the LLM system 120.

In some embodiments, and as described in more detail below, the dialogue generator 110 can generate system prompts to instruct the LLM system 120 and/or one or more guardrail observers 122. The system prompts can cause adjustment of the user prompt 112, for example adjusting the received message 118 to add the system prompts. In some embodiments, the system 100 may analyze information included within the databases to determine the system prompts. For example, the system 100 may add text in a system prompt related to a particular goal to which the outside LLM system 120 is to segue.

In some embodiments, the dialogue generator 110 (e.g., an engine implemented by the system 100) may control the transmission of information between the LLM system 120 and the user device 102. As an example, the dialogue generator 110 may adjust a message (e.g., an LLM response 114) from the LLM system prior to being transmitted to the user device 102. As one example, harmful content may be removed from the message. As another example, the dialogue generator 110 may adjust the message and cause a new message (e.g., a new LLM response 114) from the LLM system 120 to be generated. As one example, the system may update a system prompt being provided to the LLM system 120 (e.g., the updated system prompt may instruct the LLM system 120 to remove harmful content, such as a discussion of a particular scenario, to update or add language regarding a particular goal, and so on). The dialogue generator 110 may similarly adjust a message from the user device 102 (e.g., message 118) prior to transmission to the LLM system 120. For example, and as described above, the generator 110 may add system prompts. As described herein, the generator 110 may leverage input from the guardrail observers 122 to ensure that conversations satisfy the empathetic constraints described herein.

The dialogue history 130 may include records or information reflecting received messages and generated replies. For example, the history 130 may include a conversation history with a user 108 of the user device 102. Dialogue history 130 can additionally include summaries of conversation histories, for example topics of discussion, times of discussion, and so on. Additional description regarding the dialogue history is included below.

World context 132 may include information related to a number of relevant topics like one or more of weather, date, time, geolocation descriptions of businesses, utilities, and recreational activities, recent world events, or any other ancillary topic which may be relevant to the user. This information may optionally be personalized to the user, such as to the user's location, interests, family members, friends, and so on. In some embodiments, world context 132 can be linked to, or otherwise include information from, one or more externally located sources. For example, world history can be linked to Wikipedia™. The system 100 may make network calls to outside systems, such as to search for information relevant to personalizing conversations with the user. For example, the system may search for recent events related to the conversation or may search for upcoming weather related to a location of the user. The system 100 may leverage the world context 132 to provide accurate and engaging conversation to the user.

User model 134 may include information describing the user's physical and mental health conditions. These may be provided, for example, by one or more health professionals. The user model 134 may include particular goals, such as goals a health professional wants to see furthered for the user. The user model 134 may also include preferences of the user. For example, information describing the user's physical condition can include a description of how the user's mobility is limited to a wheelchair. In another example, information describing the user's mental conditions can include a description of the user's diagnosis of dementia. For health professionals (or other persons) to enter health information into a user model 134, in some embodiments the system 100 may require that the person be added to a list of credentialed personnel or otherwise authorized. While health conditions are described above, in some embodiments other information may be included. For example, and with respect to an education professional, the user model 134 may reflect educational goals associated with a student, mentee, and so on.

A goal, such as one specified or indicated by a health professional, can be a health-related achievement or a personal achievement. For example, a health-related achievement can be to reduce blood pressure. In another example, a personal achievement can be to read for thirty minutes each day. In some embodiments, a goal can be received by the system by being explicitly stated by the user. For example, the message 118 from the user include, “It is a goal of mine to read thirty minutes every day.” In this example, the goal (e.g., a summary thereof) may be generated by the system 100 (e.g., via a guardrail observer) and stored in the user model 134. In some embodiments, a goal can be provided by a health professional interacting with the system 100. For example, a nurse can say or enter text into the system 100 which states, “The user has a goal of reducing their blood pressure.” For any third party to provide a goal to the user model 134, in some embodiments the third party must receive authorization by the user or a person who established the user's 108 profile. Receiving authorization can include having a third party's credentials added to a list of persons allowed to directly generate and modify goals.

The user model 134 can additionally include follow-up topics, health data, and user preferences. Follow-up topics may include conversational points which can be mentioned when the user initially engages with the system 100 after a break from a prior conversation. When the system 100 detects a conversation is ending (described more in relation to the topic transitional structure of FIG. 4) one or more follow-up topics can be generated and held in the user model 134. The system 100 may access a topic in a subsequent conversation, and may cause the LLM system 120 (e.g., for inclusion in a system prompt) to mention the accessed topic in the subsequent conversation. Health data can include descriptions of the user's past and present mental and physical condition (a topic which will be discussed in further detail in relation to FIG. 1D). Preferences within the user model 134 can describe the user's affinity for certain types of food, music, movics, activities, places, and so on. The user model 134 may additionally indicate topics the user is not interested in talking about. The user model 134 may additionally indicate content which is considered harmful for the user to discuss, such as politics, particularly family matters, and so on.

Configurations 136 may include a user profile reflecting a set of parameters and settings which personalize an experience the user has with the system 100. The configurations 136 can include the user's name, age, sex, gender, demographic information, language settings, home address, list of persons allowed to engage in mentor mode with the user's profile, among other options. The user profile can be generated by the user or a third person on the user's behalf. For example, the user may interact with an application executing on their device 102 (e.g., the user may establish a username, password, and so on) or the user may interact with a web application associated with the system 100.

When the dialogue generator 110 directs the LLM system 120 (e.g., by modifying a user prompt 112 with a system prompt or sending a discrete system prompt to the LLM 120) to consider contextual information included in the databases 130-136, the LLM system 120 can generate an LLM response 114 which includes, or is otherwise based on, the contextual information. To direct the LLM system 120 to consider information in the databases, the dialogue generator 110 can generate system prompts including both the information to be considered and instructions to consider the information when generating the LLM response 114. For example, the dialogue generator 110 can receive a message 118 from the user 108 of, “What should I do today?” and can modify a corresponding user prompt 112 by adding a system prompt of, “Considering my arthritis” to the user prompt 112, with the condition of arthritis being derived from the user model database 134. Thus, a final prompt sent to the LLM system 120 will be “Considering my arthritis, what should I do today?” or “When responding to the following question, please assume the person receiving the answer has arthritis: what should I do today?” Upon receiving a modified user prompt 112 or system prompt, the LLM system 120 can generate an appropriate LLM response 114 or an adjustment which includes or comments on context relevant to the user prompt.

In some embodiments, the dialogue generator 110 can generate system prompts which direct the LLM system 120 to consider any health-related information, or other information, included in the databases 130-136 based on adding system prompts. For example, a system prompt can be, “When considering the following prompt from a user, consider thesc health conditions: arthritis, high blood pressure, and diabetes.” In this example, the health conditions of arthritis, high blood pressure, and diabetes are included in the user model 134 in a format which the dialogue generator 110 can identify and (through application of internal logic) add to system prompts.

In some embodiments, system prompts generated by the dialogue generation system 110 can include all information included within the databases and instructions to consider the information when responding to the user's prompt 112.

In some embodiments, system prompts generated by the dialogue generation system 110 can include at least a portion of information included within the databases and instructions to consider the information when responding to the user's prompt.

In some embodiments, multiple system prompts can be generated for a single user prompt 112, with each system prompt including at least a portion of information from a database and instructions to consider the information when responding to the user's prompt 112. When using system prompts for the user prompt 112, in some embodiments the system prompts can include instructions providing context for the LLM system 120 concerning how many system prompts will be used and how the LLM system 120 should appropriately provide the LLM response 114. For example, a first system prompt can be “There will be three prompts to follow, each including a portion of a database you are to consider, with the last prompt also including a statement or question from the user. Consider all prompts and provide a single response.” In this example, each statement in the three following system prompts will contain a portion of the information contained in the databases.

While the description above included description regarding generation of system prompts based on user information included in the databases 130-136, in some embodiments the system prompts may be generated based on other information. For example, the system 100 may generate a system prompt that instructs the LLM system 120 to stop using a particular word or to generate text in a particular way. As one example, the system 100 may indicate that the LLM system 120 should use a softer tone, a more playful tone, a tone appropriate to an age of the user, and so on.

As described herein, the system 100 may leverage guardrail observers to effectuate the empathetic conversations with users. These will be described in more detail below with respect to the guardrail observers 122 of FIG. 1C. As an example, the guardrail observers may include three modules or engines with internal logic for generating system prompts and communicating with associated LLMs included within the empathetic dialogue generation system 100. For example, there may be three LLMs executed by the system 100. In some embodiments, each of the guardrail observers may control its LLM, at least in part, through system prompts. For example, a particular guardrail observer (referred to as the watcher) may identify harmful content. In this example, the particular guardrail observer may provide a system prompt to its LLM informing the LLM that it is to watch out for, or otherwise flag, particular harmful content. The system prompt may include examples of the harmful content, specific scenarios to watch out for, and so on. As may be appreciated, these examples or information may be included in, or otherwise derived from, the databases 130-136. The internal logic in each module can, in some embodiments, be configured to generate system prompts including information from the databases and instructions for the LLMs associated with the guardrail observers 122 to perform specific analysis of the information. Guardrail observers 122 can be configured to detect harmful content within user prompts 112, detect segues to direct a user 108 towards one or more of the user's 108 goals, and identify broader context which can be applied to, or can replace, an LLM response 114.

As described in FIG. 1A, an adjusted response 116 may be provided to the user device 108. The adjusted response 116 may reflect an LLM response 114 (e.g., from the LLM system 120) which has incorporated, or been replaced by, an adjustment (e.g., from the guardrail observers 122). For example, the system 100 may have instructed the LLM system 120 via a system prompt. As another example, the system 100 may have adjusted the output of the LLM system 120 (e.g., using the guardrail observers, which as described herein may be in communication with the dialogue generator 110). As one example, the system may have removed certain text (e.g., remove harmful content), replaced certain words (e.g., use different language), and so on. The system 100 may also provide the adjusted response 116 which represents an unadjusted version of the response 114 from the LLM system 120.

In some embodiments, the adjusted response 116 can be sent to the text-to-speech module 138 (e.g., an engine) to be converted into an audio signal where it will be delivered to an audio speaker to cause generation of an audible reply 104. If the adjusted response 116 is not sent to the text-to-speech module 138, the adjusted response 116 can be sent to and displayed on a display of the user device 102 screen. For example, the avatar 106 of FIG. 1A may be rendered to output the audio. The adjusted response 116 can also be sent to the dialogue history database to be catalogued. In some embodiments, the user device 102 may receive text and output corresponding audio. The user device 102 may also render the avatar.

In some embodiments, the LLM system 120 can be a Large Multimodal Model (“LMM”), a machine learning model which functions similarly to an LLM, but which can handle different types of data. For example, an LMM can receive a text description 208 and generate a corresponding image. When a user prompt 112 is sent to the LMM, the system 100 can additionally send a system prompt instructing the LMM to generate or retrieve an image which compliments a corresponding response from the LMM (equivalent to an LLM response 114). For example, an adjusted response 116 may be “Be sure to eat at least three servings of vegetables every day.” In this example, the system 100 may generate a system prompt and send the system prompt to the LMM to generate an image corresponding to the adjusted response 116. The LMM can then generate an image, and the system can cause the adjusted response 116 to be displayed alongside the image.

The image may include an infographic 160. In some embodiments, the infographic 160 may be provided by a health professional or other domain expert. For example, using the mentor mode described herein the health professional may upload, or otherwise provide, the infographic 160 to the system 100. The health professional may additionally describe when the infographic 160 is to be used. For example, with respect to the example of eating vegetables, the health professional may indicate that when discussing healthy eating, which may be a goal of the user, the system 100 may present the infographic 160. Thus, the system 100 may include the infographic 160 in a system prompt to the LLM system 120. The system 100 may additionally include a system prompt that textually describes the infographic 160 or its relevance, and the LLM system 120 may generate text that informs the user of the infographic 160. The system 100 may additionally add the infographic 160 to the output of the LLM system 120 (e.g., the LLM response 114) to form the adjusted response 116. The adjusted response 116 may include text generated by the system 100 which is related to the infographic 160. For example, the text may be generated by the system 100, such as via one of its internal LLMs described herein, based on the description by the health professional.

FIG. 1C is a block diagram illustrating an example architecture and functioning of the guardrail observers 122. Upon the dialogue generator 110 receiving a user prompt 112 (e.g., from the user) and/or an LLM response 114 (e.g., from the external LLM system 120), the user prompt 112 and/or LLM response 114 can be provided to the guardrail observers 122 for generation of adjustments. The guardrail observers 122 may include, in some embodiments, at least three large language models which may be used in part to generate adjustments. The large language models include a watcher 124, a planner 126, and a reasoner 128. To direct generation of adjustments, the guardrail observers 122 are configured with computer-executable instructions to provide the internally located LLMs modified user prompts 112, modified LLM responses 114, or system prompts (e.g., generated by the observers 122) to direct the LLMs to generate adjustments related to specific subject matter or objectives.

The guardrail observers 122 may reflect engines which leverage respective LLMs. For example, each LLM may receive a system prompt that identifies its purpose and explains how it is to accomplish the purpose. In some embodiments, the LLM may be a pre-trained LLM which receives the system prompt. In some embodiments, the LLM may be further refined, or trained, based on examples (e.g., training examples of input and expected or intended output may be provided). Output of the LLM may be used, as one example, to generate a system prompt for inclusion in the user prompt to the LLM system 120.

The watcher 124 may include an engine which leverages an LLM that identifies harmful content in a message 118 or LLM response 114. As an example, harmful content can be phrases or words related to topics that if mentioned to a user are likely to cause the user anxiety, sadness, anger, or any other negative emotional state. Harmful content can include explicitly or implicitly political, derogatory, inflammatory, or emotionally stimulating content. For example, a message 118 can be “What time is the presidential debate tonight?” In this example, the harmful content can be the reference to the presidential debate, an inherently political topic—although the system 100 can generate replies which affirm or support the user's political opinions, engaging in such conversation may still cause the user anxiety and thus, in some embodiments or preferences of the user or domain expert, may be avoided. Thus, the watcher 124 may generate information for review by the system 100 (e.g., via the resolver 148 described below) which indicates no response should be directly given. For example, the watcher's 124 LLM may identify the harmful content and recommend a switch to a different topic. This different topic may be included in a system prompt to the LLM system 120. For example, the user prompt 112 may be generated to include the message 118 and the system prompt. The watcher's 124 LLM may also note that no direct response should be given to the question. In another example, the watcher 124 may identify a topic change with a factual answer. Thus, an LLM response 114 can be “The presidential debate is tonight at 5:30 pm, how are things going with [Topic A].” In another example, a message 118 can be “I'm going to visit my useless son today, what is the best route I should take?”. In this example, the phase “my useless son” may correspond to feelings of resentment between the user and their son and can be identified by the watcher 124 (e.g., based on the databases described herein, for example the watcher 124 may cause its LLM to monitor for specific harmful content). Thus, the watcher's 124 LLM may analyze this message from the user and identify it as including harmful content. Similar to the above, the watcher 124 may indicate a topic switch in the user prompt 112.

Similarly, the watcher 124 may adjust an LLM response 114 to form the adjusted response 116. For example, the watcher 124 may identify harmful content in the LLM response 114 and cause its removal or adjustment. As one example, the watcher's 124 LLM may remove harmful content after identifying it. As one example, the watcher's 124 LLM may adjust the LLM response 114 itself. As one example, the watcher's 124 LLM may generate a system prompt and cause an updated user prompt 112 that includes the system prompt to be provided to the LLM system 120. Thus, the system 120 may generate new output which the watcher 124 may review.

The instructions to generate prompts may include a set of pre-defined system prompts which can modify or replace user prompts 112 of LLM responses 114 depending upon context. System prompts from the watcher 124 concern commanding the LLM associated with the watcher 124 to identify harmful topics. For example, a system prompt for the watcher 124 can be “Identify harmful and controversial topics in the conversation with the user.” In another example, a system prompt for the watcher 124 can be “Generate a response to the following message 118 but avoid any political or inflammatory language in the message 118.”

The watcher 124 may therefore leverage information specific to the user, such as via access to the databases. For example, the watcher 124 may learn topics which tend to cause issues or distress with the user 108. In this example, the watcher 124 may analyze conversation histories to detect topics which inflame, or are otherwise associated with negative outcomes with, the user 108. The watcher 124 may use this information with its LLM, such as via including portions of it system prompt(s) to the LLM.

The planner 126 may include an engine which leverages an LLM that identifies segues in a conversation to introduce/mention the user's goals. While generating replies 104 which include context and syntax sufficient to engage a user 108 and mimic conversation with another person, for a prolonged conversation with the system 100 to effectively mimic human conversation (and not simply responses) there may be a structure or flow to responses. For example, a conversation history may include:
message: “What time is my son coming over today?”
Reply: “Your son is coming over today at 3:30 pm.”
message: “Thanks, I forget. Is he bringing anyone with him?”
Reply: “Your son is not bringing anyone with him.”
message: “Good. Should I cook something for him?”
Reply: “You can cook something if you want to.”

The above conversation, while including contextually relevant replies, includes replies which, in some embodiments, may be overly reactive and do not add any additional context or encourage user interaction. The conversation may be observed by the user 108 as “robotic” or “stiff.” To avoid this and other faulty conversation structures, the system 100 can apply a transitional topic structure for generating replies which directs generation of responses in a manner which effectively engages and directs the user 108.

The transitional topic structure is described in greater detail with respect to FIG. 4 but will be briefly described here with respect to its interactions with the planer 126. To identify segues to a user's goals, the planner 126 can generate system prompts which instruct the planner's LLM to explicitly identify if there is a good segue for any goals recorded in the user model 134 database and can also draw upon the dialogue history database for context. For example, a system prompt may be “Given the next message and the prior five messages, would it be appropriate for the next reply to introduce a goal?” and an adjustment can be “It is not a good time to segue to a goal” or simply “No.” In another example, a goal included in the user model 134 can be to walk for thirty minutes a day, a system prompt can be “Given the next message and the prior ten messages, if it is appropriate to segue the conversation to a goal, generate a segue, if not, say ‘no.’”, and an adjustment can be “It sounds like you're interested in exercise. Today is a great day to go for a walk.”

The planner 126 may identify a segue and generate a system prompt based on the segue. For example, the system prompt may indicate that the LLM system 120 is to segue towards a particular goal. The system prompt may include detail regarding how to segue, for example stating that the LLM system 120 is to respond to the last message with the user while seamlessly including a segue towards the goal.

In some embodiments, the planner 126 can generate adjustments based upon analysis of health data derived from a health data store 154, a health device 152 integrated with the system 100, or provided by the user 108 and included within the user model 134 database.

Similarly, the planner 126 may adjust an LLM response 114 to form the adjusted response 116. For example, the planner 126 may identify an unsuccessful segue. For example, the planner 126 LLM may identify too abrupt of a segue (e.g., based on an instruction provided to the LLM, based on training examples, and so on). The planner 126 may additionally identify that a particular goal wasn't mentioned. Thus, the planner 126 may cause a new output from the LLM system 120. For example, the planner 126 may generate a system prompt that identifies the error (e.g., lack of a segue, not directly mentioning the goal) such that the LLM system 120 will update its output.

The reasoner 128 may include an engine that leverages an LLM that identifies relevant topics and concepts in a message 118 or LLM response 114. For example, the reasoner 128 may identify, utilizing the world context 132 database, contextual information relevant and pertaining to the message 118 or LLM response 114. In this example, the reasoner 128 may then generate an adjustment which accounts for the relevant information. Relevant information can be directly or adjacently related to the user's living situation (e.g., whether it is rural, suburban, or urban), economic situation, occupation, regularly exposed to climate, among other factors. By identifying the relevant information, the reasoner 128 can generate an adjustment which can address the user's situation more succinctly than otherwise would be possible.

The reasoner 128 can operate by generating system prompts which modify the user's messages 118 (e.g., to form the user prompt 112) or LLM responses 114 or which are presented discretely, where the system prompts direct the reasoner's LLM to perform desired analysis. For example, a system prompt generated by the reasoner 128 can be, “Review previous message from the user and generate a reply to the user's latest message which accounts for their living situation.” In another example, a system prompt can be, “Generate a reply to the user's latest message while accounting for the user's living situation.” In another example, a system prompt can be, “Generate a reply to the user's latest message 118 which accounts for hobbies which are likely to appeal to people living in the user's 108 area.”

Similar to the above, the reasoner 128 may adjust an LLM response 114 to form the adjusted response 116. For example, the reasoner 128 may identify that the LLM response 114 did not address the user's living situation. The reasoner 128 may therefore update a system prompt to the LLM system 120 to cause expected output.

The guardrail observers 122, in some embodiments, can have access to two or more of the databases when generating adjustments. Having access to multiple databases can be functionally treated as one larger database. Discerning between data included in either database can be allowed by a plurality of means, including structuring the data with appropriate labels. For example, to identify saved message 118 in the dialogue history database, each message 118 or reply can be modified with the text “This is a message 118:” or “This is a reply:”, corresponding to a saved reply of “You could take a nap.” being saved in the dialogue history database as “This is a reply: You should take a nap.” In another example, goals saved in the user model 134 can include modification with the text “This is a goal:”, corresponding to a goal of “Walk thirty minutes every day” being saved as “This is a goal: Walk thirty minutes a day.”

The system 100 may leverage a multiplexer 150—a computational module including a data structure for holding and processing messages 118 and LLM responses 114—to receive, organize, and provide the messages 118 or LLM responses 114 to the guardrail observers 122. Conversation can progress at quick pace, with the conversation being generated rapidly. To ensure each message 118 is correctly associated with an LLM response 114, each message 118 and LLM response 114 may be sent to and categorized within the multiplexer 150. The multiplexer 150 can determine which messages 118 and LLM responses 114 get sent to the guardrail observers 122. In some embodiments, a message 118 will be sent to the guardrail observers 122 followed by a corresponding LLM response 114. In some embodiments, user prompt 118 can be sent to the guardrail observers 122 and corresponding adjustments can be catalogued so as to be identified with a corresponding LLM response 114 sent to the guardrail observers 122 at a later time.

For example, a dialogue generator can receive a first and second message from the user. In this example, several sets of operations can be performed to process the user prompts 112:
The first message, such as an associated first user prompt, can be sent to the LLM system 120, such that a first LLM response can be received. Then, the first user prompt can be sent to the multiplexer 150, followed by the first LLM response 114. Next, the second message, such an associated second user prompt, can be sent to the LLM system 120, such that a second LLM response can be received. Then, the second user prompt can be sent to the multiplexer 150, followed by the second LLM response. In this example, the guardrail observers 122 may process the first message (to form the first user prompt) and then the first LLM response 114, where corresponding generated adjustments can be analyzed together to determine which is more appropriate (performed in the later described resolver 148). Next, the guardrail observers may process the second user prompt and second LLM response 114, wherein corresponding generated adjustments can be analyzed together.
The first user prompt can be sent to the multiplexer 150, followed by the second user prompt being sent to the multiplexer 150. The first user prompt can be sent to the LLM system 120 to generate a first LLM response and the second user prompt can be sent to the LLM system 120 to generate a second LLM response. Next, the first LLM response can be sent to the multiplexer 150 and then the second LLM response can be sent to the multiplexer 150. As contents of the multiplexer 150 are sent to the guardrail observers 122 and corresponding adjustments are generated, the adjustments can be analyzed by the resolver 148 in the order in which they were received.

In both situations, analyzing adjustments in relation to appropriate sets of messages and LLM responses can be dictated by logic internal to the resolver 148. For example, potential adjustments by the guardrail observers 122 may be routed to the resolver 148 (e.g., via queue 146). These adjustments may be presented to the resolver 148 in an order corresponding to generation by a first message, a second message, a first LLM response 114, and a second LLM response 114, the resolver 148 can review every other set of adjustments as a set. In another example, if adjustments are presented to the resolver 148 in an order corresponding to generation by a first message, a first LLM response, a second message, and a second LLM response, the resolver 148 can review two adjacent sets of adjustments together. Analyzing contents of a multiplexer 150 can be done by examining which types of adjustments are present and selecting adjustments based on system preferences. For example, if a first user prompt 112 corresponds to an adjustment being generated from the planner 126 and a first LLM response 114 corresponds to an adjustment being generated from the reasoner 128, the resolver 148 can select from the available adjustments based on internal priority. In some embodiments, the priority ranks highest for adjustments from the watcher 124, then from the planner 126, and then from the reasoner 128. In instances in which multiple adjustments from the same guardrail observer 122 are available, the resolver 148 can select which adjustment was received first.

The guardrail observers 122 may generate adjustments individually, and not, in some embodiments, as a combined unit. In some embodiments, the watcher 124, planner 126, and/or reasoner 128 may or may not generate an adjustment. If the watcher 124 does not identify any harmful content, the watcher 124 will not generate an adjustment. If the planner 126 does not identify any goals for which segues can be appropriately generated, the planner 126 will not generate an adjustment. If the reasoner 128 does not identify any applicable, broader context which could be added to or replace an LLM response 114, the reasoner 128 will not generate an adjustment.

After being generated, adjustments are passed by the guardrail observers 122 to a queue 146, which includes a data structure capable of holding the adjustments and presenting the adjustments to the resolver 148. The queue 146 can be any data structure capable of holding the adjustments in a usable format.

The resolver 148 receives adjustments from the queue 146 and determines which adjustment will be selected. In some embodiments, selection of adjustments can be dependent upon a prescribed priority, wherein adjustments are selected based upon a hierarchical preference for adjustments derived from either the watcher 124, planner 126, or reasoner 128. In some embodiments, the hierarchical preference can include a fist preference for adjustments from a watcher 124, a second preference for adjustments from a planner 126, and a third preference for adjustments from a reasoner 128. In some embodiments, the guardrail observers 122 may include a priority associated with their adjustment. For example, the output of their associated LLMs may include the recommended adjustment for inclusion in a system prompt to the LLM system 120 along with an associated priority. Thus, the resolver 148 may prefer a higher priority. In some embodiments, the resolver 148 may select adjustments from two or more guardrail observers for inclusion in a system prompt to the LLM system 120.

In some embodiments, adjustments can further be prioritized depending upon whether they derive from a message 118 or an LLM response 114. Adjustments derived from a message 118 can be preferred over adjustments derived from a corresponding LLM response 114.

In some embodiments, adjustments generated from messages 118 can be used to modify or replace use prompts to generate adjusted prompts, wherein the adjusted prompts can be sent to the LLM system 120 so as to receive an LLM response 114.

Once received by the dialogue generator 110, adjustments can be selected or applied. For example, the dialogue generator 110 may include a system prompt in the user prompt 112 to the LLM system 120 based on the output from the resolver 148. In some embodiments, an adjustment can replace an LLM response 114 and can be used to generate an audible or visual reply 104. In some embodiments, content from an adjustment can be applied to an LLM response 114 so as to adjust the LLM response 114. For example, an LLM response 114 may be “Today, you should take a nap.” and an adjustment may be “go for a walk”, wherein the adjustment corresponds to a goal of the user. In this example, the dialogue generator 110 can adjust the LLM response 114 to include content of the adjustment so that the adjusted response 116 will be “Today, you could go for a walk.” The generator 110 may additionally use a current weather, for example obtained based on a network call by the system 100, to respond with, “Today is sunny, it may be nice to go for a walk.” Determining where to insert adjustments to modify LLM responses 114 can be done with the LLM system 120 or one or more guardrail observers 122. For example, an LLM response 114 may be “Today, you could read a book.” and an adjustment can be “call your mother.” In this example, modifying the LLM response 114 can involve sending the following prompt to an LLM “Modify the message 118 ‘Today, you could read a book.’ with the adjustment ‘call your mother.’ in an appropriate manner.’”

FIG. 1D is a block diagram illustrating an example architecture and functioning of the empathetic dialogue generation system 100 integrating with one or more health devices 152 and receiving and integrating health data from a health data store 154. A user model 134 can be a database including information defining factors and descriptions of a user's 108 health history and conditions, among other topics. For example, the user model 134 can include information describing if a user 108 has dementia, diabetes, cancer, paralyzed lower extremities, or any other condition. By supplying information from the user model 134 for analysis by the guardrail observers 122, adjustments can be generated which account for the user's 108 health condition and history.

To receive health data, a user 108 can engage with the empathetic dialogue generation system 100 to manually enter descriptions of the health data; the empathetic dialogue generation system 100 can integrate with a health data store 154; or the empathetic dialogue generation system 100 can integrate with one or more health device(s) 152 to receive measurements and readings of a user 108 (e.g., sensor measurements). Manually entering descriptions of health data can be performed while establishing a user 108 profile (either by the user 108 or someone acting on behalf of the user 108, like a family member or health staff) and can involve providing a text message 118 or audible message 118 to the empathetic dialogue generation system 100 describing the user's 108 health data. Receiving health data from a health data store 154 can include integrating the empathetic dialogue generation system 100 with an externally located health data store 154, which can be a web-based database which can be integrated with and accessed so as to retrieve health data relevant to the user 108. A health device 152 can be a heart rate monitor, a blood glucose monitor, a blood pressure monitor, a temperature sensor, or any other device configured to receive readings of a user's 108 health condition. The empathetic dialogue generation system 100 can integrate with a health device 152 by the user device 102 integrating (physically or through a wireless communication method) with the health device 152 and receiving health data from the health device 152.

By receiving health data, the empathetic dialogue generation system can add additional context to adjusted responses 116. For example, if health data states that a user 108 is a diabetic, the guardrail observers 122 can generate adjustments which: recommend food choices which are low in sugar, remind the user 108 to monitor glucose when an appropriate time is additionally detected from the world context 132 database, or remind the user 108 to speak with their health professional periodically. In another example, if health data corresponds to the user 108 having high blood pressure, the guardrail observers 122 can generate adjustments which advise the user 108 to speak with a health professional about their blood pressure.

The health data can be processed by the system 100 to perform analyses. An example analysis may include identifying one or more trends and points of interest. For example, the system 100 can direct the guardrail observers 122 to analyze user prompts to identify health-related factors to enable detection of health-related trends. As an example, health data can include a user's blood pressure readings. For this example, the system 100 can identify trends in the user's blood pressure as they relate to conversation with the system 100. Thus, the system 100 can determine whether the conversations are causing a decrease in the user's blood pressure. Similarly, and with respect to a glucose monitor, the system 100 can determine whether the conversations are resulting in more frequent glucose monitor readings by the user. This information may be saved by the system 100 and reviewed by the user or a health professional, or other mentor, using the mentor mode described herein. For example, a health professional can ask the system if the user has been more frequently using their glucose monitor.

In some embodiments, health device 152 may include environmental sensors, humidity sensor, water quality sensor, temperature sensor, physiological/biometric sensors (e.g., blood pressure sensor, glucose sensor, heart rate sensor, oxygen sensor, and so on).

### Avatar Generation

In some embodiments, the empathetic dialogue generation system 100 can include an avatar generation system 200 which can generate an avatar, a visual image which can be animated so as to mimic dialogue corresponding to an audible reply. In some embodiments, an avatar may be generated using deep learning image techniques such as pix2pix, vid2vid, and so on.

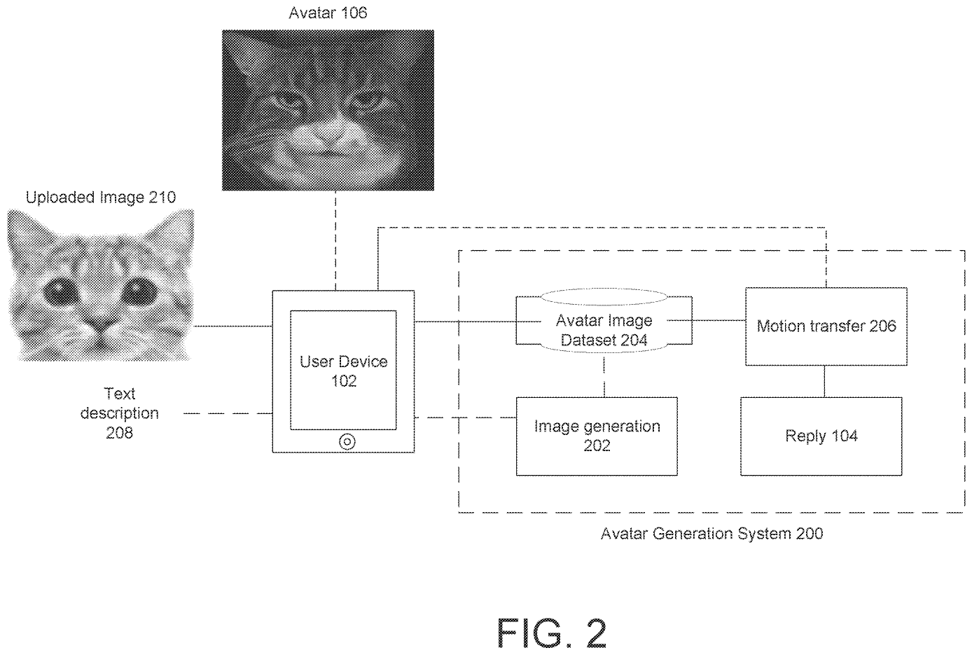

FIG. 2 is a block diagram illustrating an example architecture and functioning of the avatar generation system 200. The system 200 may, in some embodiments, be implemented or form part of the system 100. The system 200 may also, in some embodiments, be executed by an outside system (e.g., a cloud system) in communication with the system 100. Generating an avatar involves receiving an image or a description of an image, performing image generation 202 (if a description of an image was received), uploading the image into an avatar image dataset 204, receiving a generated reply and implementing motion transfer 206, and generating a moving avatar.

An image can be uploaded 210 to the avatar generation system 200 by a user 108 interacting with a user device 102 which includes the empathetic dialogue generation system 100 and the avatar generation system 200. An image can be of an animal (including the animal's face), a person, a cartoon, a plant, fungi, or an object, although generally the image will be of an animal. If, instead, a text description 208 is received, the text description 208 can be received by a user 108 physically entering text describing an image or the user 108 audibly describing an image and the audible description being received by the user device 102 and converted (via the text-to-speech module 138) into a text description 208. For example, a text description 208 can be “A monkey” or “A cat.”

The text description 208 can then be used in conjunction with a generative model to generate an image matching the text description 208. The image, whether received or generated, can be provided to the avatar image dataset 204, a data structure including images used to generate avatars. The avatar images can be provided to a motion transfer 206 module and analyzed so as to identify portions of the images which best correspond to a mouth which can be simulated to move. If the image includes a non-animal, like a fruit or another object, a portion of the image will still be identified as a mouth and will be accordingly processed. The image will used to generate a set of alternative frames—alterations of the image with portions of the subject of the image warped to simulate different stages of speech—which, when combined, simulate movement of a mouth. By presenting the set of alternative frames and the image, the image can appear to speak. The motion transfer 206 module can additionally receive generated replies and can provide the alternative frames and the image in a progression so as to match an audible reply. Whenever a new reply is audibly generated, the alternative frames and the image (collectively referred to as the “avatar”) can be displayed to match the new reply.

In some embodiments, the avatar and/or conversations may have different modes. For example, a companion mode may be selected which will cause the system 100 to engage the user in conversations to improve mood, offer humor, actively listen and respond. For example, the system 100 may use user goals and topics to offer responses that include humor, up-lifting stories, and so on. Another example mode may include nap mode. This mode may include the avatar lying down and snoozing quietly. The avatar may stay quiet until the user initiates conversation or has been set up to start a conversation or remind the user at a particular time. Another example mode may include memory mode. For this mode, the avatar may engage its user in conversations aimed at improving memory recall. The avatar may keep track of the user's stories from the past, for example the system may store the conversation history as described herein. At random days and times, the avatar may comment or ask a question about the stories to nudge the user into recalling a memory. This memory might be an event, such as a wedding, or an experience, such as a trip. Memory mode may be used for important reminders, such as appointments or medication times.

Another example mode may include report mode. For this mode, the system may provide a tool for users of the system to access context-sensitive situational awareness of the user. Another example mode may include coach mode. For this mode, the system may support the user by gently nudging conversations to talk about movement and exercise, or other goals, as described herein. Another example mode may include helper mode. For this mode, the system has take notes it can later recall. For example, the system may store summaries of conversations, such as likes, dislikes, of the user, topics frequently mentioned, and so on. The system may use these to bring up specific likes later on, or to avoid particular dislikes. Another example mode may include sharing mode, in which the system may share information by authorized users via, for example, an API.

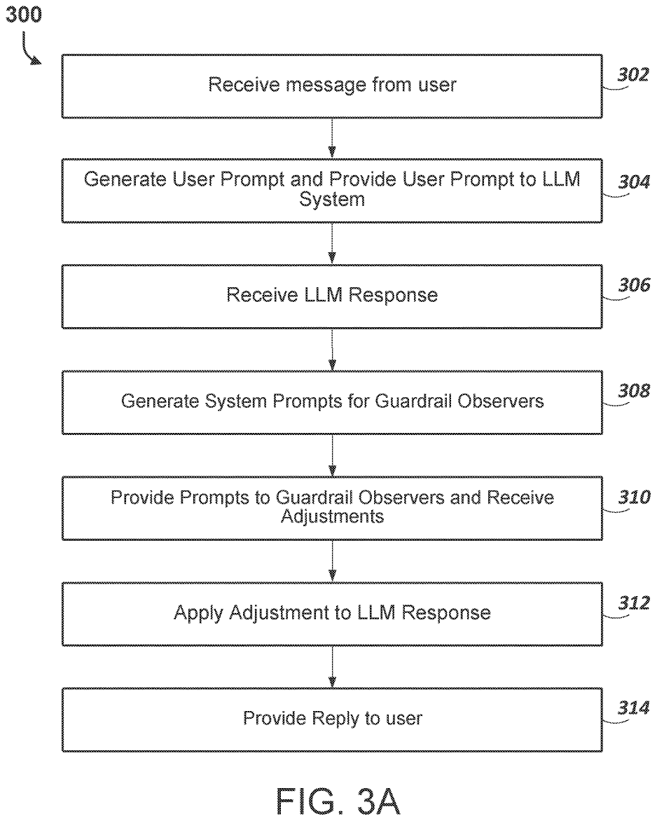

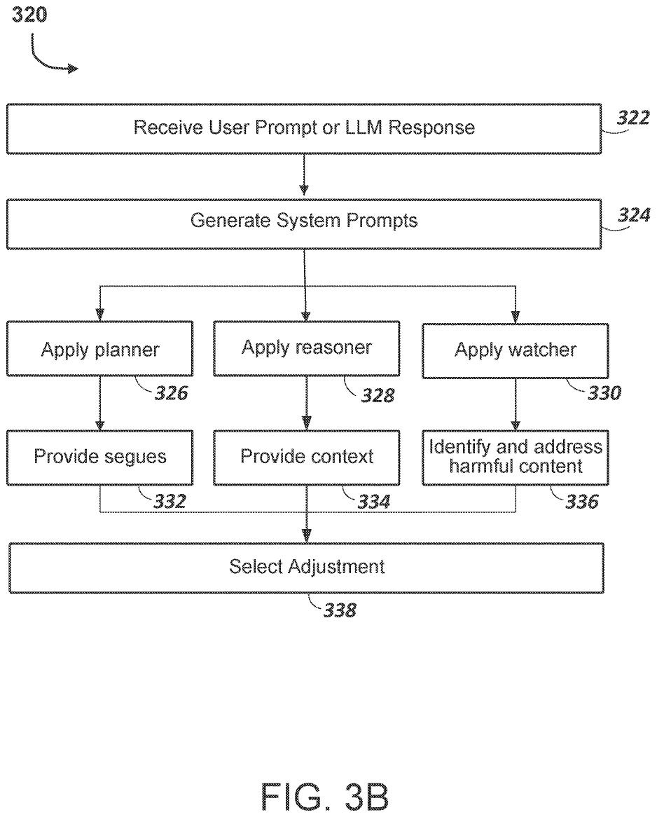

FIG. 3A is a block diagram describing a method 300 of generating conversation with a user 108. The process 300 may be performed, for example, by the system 100. Additional description related to FIG. 3A may be found in at least FIGS. 1A-1D with respect to the system.

At step 302, a message 118 is received from a user 108 in the form of text or audio. At step 304, pre-processing is applied to the message 118 to generate a user prompt 112. The user prompt 112 is then provided to the LLM system and an LLM response 114 is received at step 306. Thereafter, at step 308, the system can generate system prompts to be provided to the guardrail observers to direct the corresponding LLMs to perform specific actions. The system prompts either supplement or include reference to the user prompt 112 or LLM response 114 and, at step 310, upon being received at one of the guardrail observers, cause analysis of the user prompt 112, LLM response 114, and/or one or more databases. At step 312, after analysis, one or more adjustments are received from the guardrail observers and provided to a resolver 148, which selects an adjustment, wherein the system can apply the adjustment to the LLM response 114, corresponding to either modifying the LLM response 114 or replacing the LLM response 114 with content from the adjustment, generating an adjusted response 116. Notably, if guardrail observers do not generate any adjustments, the LLM response 114 is still considered an adjusted response 116 for computational purposes. Lastly, at step 314, the adjusted response 116 is then provided to a user 108 either in the form of a text message 118 or an audible message 118 after the adjusted response 116 is provided to a text-to-speech module 138 and converted into an audible signal.

While the description above described the guardrail observers analyzing the user prompt 112 and LLM response 114, as described herein the system may additionally analyze the message 118 using the guardrail observers to form the user prompt 112. For example, the guardrail observers 118 may analyze the message 118, optionally along with at least a portion of a prior conversation history. In this example, the guardrail observers may generate system prompts, or other adjustments, to the message 118. The system, such as by the resolver described herein, may select one or more of the adjustments and the system, such as via the dialogue generator, may generate the user prompt 112.

Similarly, the system may additionally analyze the LLM response 114, optionally along with at least a portion of a prior conversation history. In this example, the guardrail observers may generate system prompts, or other adjustments, to the LLM response 118. The system may cause an updated LLM response to be generated, for example by sending one or more of the system prompts to the LLM system. The system may also adjust the LLM response 114 based on the guardrail observers, for example it may remove text, adjust text, and so on.

FIG. 3B is a block diagram describing a method 320 of generating adjustments with guardrail observers. The process 320 may be performed, for example, by the system 100. Additional description related to FIG. 3B may be found in at least FIGS. 1A-1D with respect to the system.

First, at step 322, a message 118 or LLM response 114 is received by the system. At step 324, the system can then generate system prompts, commands which can complement or modify messages or LLM responses provided to guardrail observers. The system prompts may be generated to apply to specific guardrail observers, certain system prompts for the planner, reasoner, and watcher individually.

At steps 326, 328, and 330, the message 118 or LLM response 114 and the system prompts can be sent to the planner, reasoner, and watcher to cause corresponding analysis and generation of adjustments. At step 332, the planner is configured to receive system prompts which cause the planner to analyze the message or LLM response, optionally along with a conversation history, and one or more databases to determine appropriate segues to support one or more user 108 goals. At step 334, the reasoner is configured to receive system prompts which cause analyses of the message or LLM response, optionally along with a conversation history, and one or more databases to generate adjustments which account for broader situational context of the user. At step 336, the watcher is configured to receive system prompts which cause the planner to analyze the message or LLM response, optionally along with a conversation history, and one or more databases to generate adjustments which have removed harmful subject matter.

At step 338, the adjustments are provided to a queue 146, a data structure which holds and organized the adjustments, wherein the queue 146 provides the adjustments to a resolver 148 which selects an adjustment for application to the message (to form the user prompt) or LLM response 114.

### Topic Transition Structure

As previously mentioned, for a conversation to feel natural and engaging, responses must do more than recite information included in user messages 118, the responses must follow a conversational flow and cadence. Furthermore, introduction of topics and concepts in an overly assertive manner can similarly seem to a user 108 as jarring or unengaging. To accomplish effective conversation, the empathetic dialogue generation system 100 can include a conversational structure.

FIG. 4 is a block diagram illustrating an example implementation of a topic transition structure 400. The topic transition structure includes operational phases which correspond to sets of instructions which control and guide which types of LLM responses 114 and adjustments are generated. Driving the topic transition structure is generation of system prompts, commands which can complement or modify messages 118 or LLM responses 114 to induce specific operations. The topic transition structure includes a set of steps corresponding to specific system prompts being sent to specific guardrail observers and/or the LLM system 120.

The structure beings at step 402, an offering of a greeting to a user 108. A greeting can be generated by a system prompt being generated which instructs an LLM to generate a greeting discretely or in connection with user prompt 112. For example, the system can receive a message 118 of “What time is it?” and generate a system prompt of “Generate a greeting and responds to the following message 118.”, wherein a corresponding LLM response 114 can be “Good morning. It is nine-thirty a.m.”. For this example, the system may obtain a current time (e.g., the question may trigger access to an outside system or service to respond to the question).

Next, the system can proceed to step 404, a chit-chat phrase. In some embodiments, a threshold number of replies may be required prior to seeking to perform any other task or introduce another topic (e.g., introduce a goal). Engaging in chit-chat can involve replying to messages 118 in a straight-forward manner. For example, a message 118 can be “What time is it?” and a reply can be “It is nine-fifteen in the morning.” In some embodiments, the threshold number of replies is 3, 4, 5, or set by a health professional. Thus, the system 100 can avoid segueing into messages regarding goals without some initial discussion (e.g., chit-chat).

After the threshold number of replies has been sent, the system can proceed to step 406, for which the system can begin sending prompts to the guardrail observers with instructions to generate adjustments which segue into one or more topics corresponding to goals 412 included the User model 134 database. Prior to this threshold, the system may optionally provide messages to the guardrail observers (e.g., to identify harmful content, and so on). System prompts to generate segues to goals can optionally be explicit requests to do so. For example, a system prompt in step 406 can be, “Generate a segue to a user goal. If such a statement is not appropriate at this phase of the conversation, return the word ‘No.’” If the guardrails do not generate an adjustment after receiving the system prompt, the system can return to step 404 to resume the chit-chat phase.

If an adjustment towards a goal is generated, the system can proceed to step 408, where deliberation can occur to select which adjustment to utilize when generating an LLM response 114. If a single adjustment is received, the system may select the adjustment and either modify an LLM response 114—by sending both the adjustment and LLM response 114 to an LLM and requesting the LLM perform the modification—or replace the LLM response 114 with the adjustment. If there are multiple adjustments, the adjustments can be organized into a queue 146. In some embodiments, the adjustments can be selected in order or based on priority information. Upon selection, adjusted responses 116 will be generated and presented to a user 108 which recommend topics supportive of one or more user 108 goals.

After recommending a user 108 goal, the system can proceed to step 410, wherein the system can follow up on topics 414 mentioned in relation to the user 108 goal. Follow-up can involve asking clarifying questions or performing analysis on future messages 118 to detect if the user 108 has made progress towards accomplishing one or more goals. If progress is identified, the system can record within the user model 134 that the one or more goals are being achieved. System prompts corresponding to step 410 can include directions to one or more LLM to consider a recent or upcoming message 118 in relation to the mentioned goal. For example, a reply concerning a goal can be “Consider going for a walk, it is great exercise.” In this example, a system prompt generated during follow-up can be “Focus on the recommended activity in the previous reply when reviewing the following message 118 and identify if progress has been made towards achieving any user 108 goals.” In another example, during the follow-up phase, the system can generate a reply of “Are you making progress with healthy eating?” After follow-up, the system can return to step 404 to engage in chit-chat.

Transitioning to each structure involves generating and applying one or more system prompts which ask one or more LLMs if transitioning to the next conversational phase is appropriate. Thus, at both step 406 and 408, if a corresponding LLM generated an LLM response 114 (e.g., an external LLM) or adjustment which instructs the system to return to a preceding step, the system can oblige. In this way, conversations can be adaptive as they respond to organic changes and flow of each conversation.

In some embodiments, if generation of an LLM response 114 or adjustment is taking a large amount of time-due to computational processes or any other reason-the system can generate a reply from a set of pre-made replies. Pre-made replies can be questions ascertaining a user's 108 condition or opinion or can be statements which generally relate to one or more topics. For example, a pre-made reply can be “While I figure that out, tell me more about your day.” In another example, a pre-made reply can be “Let me consider that.”

### Turn Count

Related to the topic transitional structure is a functionality of turn counting, wherein the system 100 can identify topics which have been mentioned to a user 108 and can count how many messages 118 and replies take place between successive discussions of the topic. A turn can refer to a message 118 or reply. Applying turn counting includes restricting which topics can be covered until a minimum number of turns have taken place since a previous instance of a topic being discussed. For example, the system can suggest a user 108 eat more vegetables and can refrain from mentioning the topic of eating vegetables until a minimum number of pre-configured turns (e.g., a threshold number of turns, such as 2, 5, 75, 100) have taken place since the topic was discussed.

In some embodiments, the turn count can be used by the topic transition structure to select an adjustment to recommend user 108 take actions to progress towards achieving a goal. At step 408, during deliberation, the method can select between recommended topics by selecting a topic with a smallest corresponding turn count.

In some embodiments, the disclosed technology enables ‘adaptive topic trajectories in empathic dialog systems working within multi-session environments. For empathic dialog systems to support multiple sessions properly, the system may ‘remember’ previous topics discussed from previous sessions then make progress on topics that need further deliberation. Further empathic dialog systems may avoid excessive discussions on a single topic within sessions and across multiple sessions. Moreover topics that are brought up by empathic systems on some defined time such as that required to give reminders to users, may have empathic dialog systems to support timely changes in topic trajectories that the emphatic dialog system is considering. Non-limiting examples of reminders include user-defined reminders and system-defined reminders. An example of user-defined reminders might be appointments and/or medication reminders. An example of system-defined reminders might be prompting the user to recall a memory and/or reminding the user of new lifestyle behaviors, such as taking a regular walk.

In some embodiments, during a dialog session, a turn-count is assigned to each turn in the dialog within the session. For example, a greeting from the system (e.g., ‘how are you’) may be assigned turn-count 1, the subsequent response by the user (e.g., ‘I am doing great’) may be assigned turn-count 2, and so forth.

Adaptive topic trajectories may, in some embodiments, build on the system architecture described above, for example the system may track the state of the dialog using a conversation state structure. For example, nodes which form a conversation policy graph structure point may point to tables including lists of transitional goals and topics. For example, the ‘introduction’ state points via a topic trajectory to the table containing a list comprising the following transition goals and topics: (1) ‘healthy eating’, and (2) ‘regular exercise’. Similarly, the topic of ‘healthy eating’ points to a list comprising the following sub-topics: (1) ‘low sodium diet’, (2) ‘balanced diet’, and (3) ‘reduce fat intake,’ and the topic of ‘regular exercise’ points to a list comprising the following sub-topics: (1) ‘low-impact walk’, and (2) ‘swimming’.

While the dialog is in an ‘introduction’ state, the dialog may transition either to the topic of ‘healthy eating’ or ‘regular exercise’. In the instance where the dialog has transitioned to the topic of ‘healthy eating,’ and when the dialog is in the ‘deliberation’ stage, the dialog may now transition to the sub-topic of low sodium diet, the sub-topic of ‘balanced diet’, or the sub-topic ‘reduce fat intake.’ Each dialog session may optionally beo assigned a number. For example, Session numbers may be further annotated with the current date and timc.

Each node ‘reached’ in a dialog may be marked with (1) a session number (a monotonically increasing number representing the session the dialog is in), (2) the current turn-count, and (3) the detected sentiment in the user's response. For example, during the first session (i.e., session 1), a ‘greeting’ node, ‘chit-chat’ node, ‘introduction’ node, and the ‘deliberation’node may be marked with a ‘1’ corresponding to the session number.

The disclosed technology may remember to continue a discussion in a subsequent session (e.g., session 2). For example, the system may update a ‘chit-chat’ node to point to a new ‘re-introduction’ node which refers to a new single entry ‘healthy eating’ topic table. Therefore, in session ‘2’, the new topic trajectory may be used to re-introduce the ‘healthy eating’ topic again.

Over the course of multiple sessions and topic trajectories, the disclose technology may collect statistics, where non-limiting examples of such statistics include: (1) the amount of effective time spent (in sessions and turns) on different topics, (2) statistics related to the perceived user response and engagement on each topic, (3) last turn-count(s) when topics were discussed, (4) last session(s) when topics were discussed, etc.

The system may optionally schedule topics in a future session based on a request from the user. In this non-limiting example, the user indicates in this session dialog that the user would like to be reminded about the topic of managing stress. In response, the system inquires what days/times such a reminder is required. Based on when such a reminder is required, the system 100 stores information scheduling a topic trajectory change by enqueuing the topic ‘manage stress’ and sets a timer that triggers the update on the requested schedule. For example, a guardrail observer may segue into the topic change.

### De-Identification

In some embodiments, the empathetic dialogue generation system 100 can de-identify user prompts 112 which include identifying information of a user 108 in relation to the user's 108 protected health information or other personally identifiable information.

During typical operation of an LLM, content of a user prompt 112 is sent uncensored to the LLM when generating an LLM response 114. An issue with such a process is the ability of sensitive information to be passed to the LLM. Examples of sensitive information may include regulatory-controls on health information, children's information, financial information, and so on. As LLMs are learning models which need to draw upon vast quantities of text data, often, LLMs will add received user prompts 112 to a referenced collection of training data, allowing content of user prompts 112 to be learned from. Even in instances in which user prompts 112 are not directly added to training datasets, LLM responses 114 to such prompts often are used as training data. Being that LLM responses 114 often reference and include the same or similar content as corresponding user prompts 112, a user prompt 112 including sensitive information, protected health information or personally identifiable information, can cause generation of an LLM response 114 which includes some of or all of the sensitive information or includes variations of the sensitive information which would allow an inductive reconstruction of the sensitive information. And even in situations in which an LLM is programmed in a manner which does not learn from user prompts 112 or LLM responses 114, the act of sharing a user's 108 sensitive information is itself an ethical violation, especially when the sensitive information relates to a user's 108 health condition.

Therefore, the empathetic dialogue generation system 100 additionally includes functionality which can de-identify a user's 108 sensitive information, including name, address, health details which make a user 108 identifiable, social security number, identification number (such as a driver's license or state I.D. number), etc.

De-identification of a user's 108 sensitive information can be performed internal to the empathetic dialogue generation system 100 during pre-processing. De-identification can involve providing system prompts directing the guardrail observers to remove sensitive information. De-identification can include replacing the sensitive information with generic variations which are contextually accurate, but which lack identifiable features. For example, a user's 108 name can be replaced with a generic name like “John Doe” or “Jane Doe.” In another example, a user's 108 address can be replaced by a generic address like “12345 Street.” The system can be configured to replace sensitive information with generic stand-ins, wherein after providing corresponding user prompts 112 to the LLM system, received LLM responses 114 can have the stand-in information replaced by user 108-specific information so as to allow replies to include and reference proper context. In this way, sensitive information can be removed while generating LLM responses 114 and then sensitive information can be added when generating replies from the LLM responses 114.

### Mentor Mode

As content of adjusted responses 116 is based upon operation of multiple LLMs, there is potential for the system 100 to learn to generate more effective/appropriate adjusted responses 116. As previously described, the guardrail observers 122 can use received user prompts 112, LLM responses 114, and adjustments as additional training data. However, if one or more guardrail observers 122 begin generating suboptimal adjustments, there is little that can be done through supplying messages 118 to correct sub-optimal adjustments. To remedy this deficiency, the system 100 can include a mentor mode, wherein a mentor profile may interact with a history of user prompts 112 and LLM responses 114 and corresponding adjustments to supply corrections and model adjustments. A mentor can be a family member of the user 108, a friend of the user 108, a health professional who works with the user 108, an education professional, or any other authorized person (e.g., with valid credentials). For example, the mentor may be a domain expert.

While a user 108 profile is being established, a corresponding mentor profile can be generated to allow a person other than the user 108 to interact with the system 100. A mentor profile can be a set of permissions and identifications which allow a specified person to interact with the user 108 profile in an administrative capacity. Generating a mentor profile can include providing credentials corresponding to a mentor-a person whose identify is associated with the mentor profile-to allow the mentor to interact with the user's 108 profile with the privilege to make modifications to one or more aspects. A mentor, through accessing the mentor profile, can review a user model 134 database and a dialogue history database. Reviewing the user model 134 database allows the mentor to access health information which can been recorded through conversation with the user 108 or which has been obtained via a biosensor. Reviewing the dialogue history database allows the mentor to review user prompts 112, LLM responses 114, and corresponding adjustments, and make changes. The system 100 can assist the mentor with finding relevant information in a database.

Upon reviewing the dialogue history database, the mentor can provide—either via text or audible message—alternative versions of adjustments, allowing the system 100 to later review the alternative versions of adjustments when the guardrail observers are generating adjustments.

For example, a user prompt 112 recorded in the dialogue history database can be “What should I do today?” and a recorded adjustment can be “You could go for a walk today.” The mentor can provide an alternative adjustment of “You could call your friends today.” When the guardrail observers 122 are responding to future user prompts 112 and/or LLM responses 114, the guardrail observers 122 will be able to access the alternative adjustment and not the original adjustment, thus allowing the alternative adjustment to shape generation of future adjustments.

Using mentor mode, a health professional may specify goals which they prefer specific user(s) 108 to further. For example, the health professional may indicate that user 108 A should try to go for a walk every day in a park. In this example, the health professional may communicate with the system 100 to indicate these goals. The guardrail observers 122 may then ensure that future conversations with user 108 A introduce, or segue, into these goals at times appropriate. For example, the guardrail observers 122 may be provided with system prompts that indicate, or otherwise identify locations of, the goals. Thus, the observers 122 may identify the goals and determine appropriate times at which to introduce them into discussion.

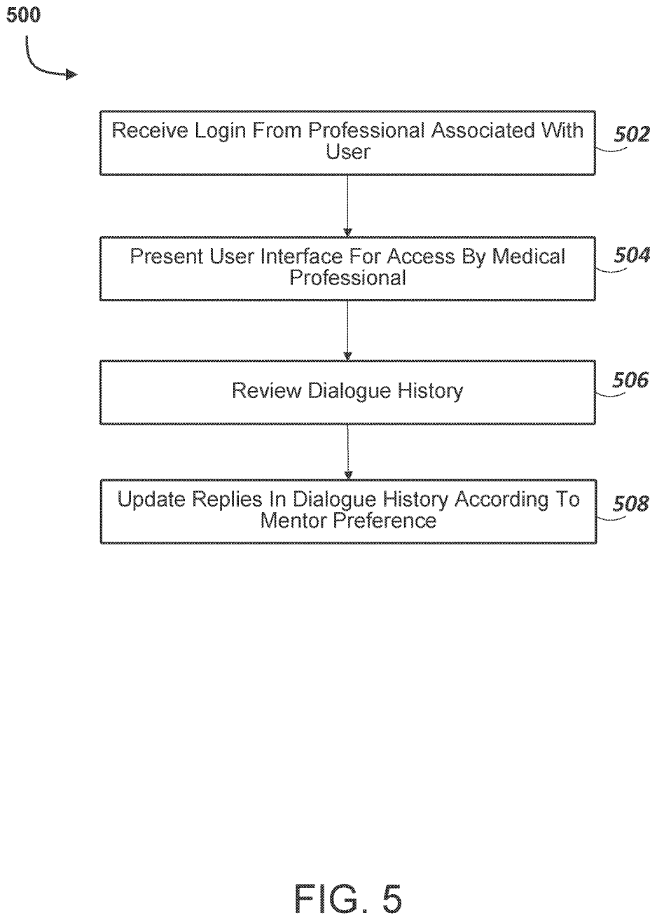

FIG. 5 is a block diagram illustrating a process 500 of employing the mentor mode. The process 500 may be performed, for example, by the system 100.

First, at step 502, the system will receive login information from a domain expert (e.g., a health professional) associated with a user's 108 profile, wherein the user's 108 profile will include a list of persons authorized to access mentor mode. Next, at step 504, the system will present to the domain expert a user 108 interface including options to interact with the user's 108 profile. At step 506, the user 108 interface will enable review of the user's 108 dialogue history, displaying identified instances in which the user 108 stated something which suggests or is analogous to an aspect of a domain of interest. Additionally, the domain expert may cause the system to search for instances of text or instances of specific scenarios (e.g., did you discuss [topic A] with user?”

At step 508, the user 108 interface enables modification of replies to affect future generated replies to be more in line with a mentor's desired output. In some embodiments, the system can offer an exemplar of future generated replies for the mentor to review and potentially change further.

In some embodiments, when a domain expert is interacting with a user's 108 profile at step 506, the domain expert can provide messages audibly or through text to the system 100 corresponding to questions about a user's 108 profile, and the system 100 can provide replies 106 which answer the questions. For example, a domain expert can be a teacher and can ask the system 100 “Did you discuss eating healthy foods with the user?” and the system 100 can generate a response “Yes, I spoke with the user about eating healthy foods” or “No, I did not speak with the user about eating healthy foods.”

As may be appreciated, communicating with the system 100 may include the domain expert, such as a health professional, communicating with an LLM. The LLM may be, in some embodiments, locally run by the system 100 to ensure privacy associated with conversations.

The LLM may have access to conversation history with a user, such as a patient of the example health professional. For example, the LLM may receive at least a portion of the conversation history in its context window (e.g., as a system prompt). As another example, the system may search for specific queries related to the health professional's conversation. For this example, the health professional may ask if the system discussed healthy foods. Thus, the system may search for text related to healthy foods and may provide responsive results in the context window of the LLM.

Thus, the domain expert may ask questions to the system 100, such as “Did you speak with [user A] about her health condition recently?” The system 100 may use an LLM to respond with, “Yes, talked about her challenges walking up stairs and I described I had a friend who had similar challenges.” The domain expert may then respond with, “please avoid saying that you had a friend with similar experiences and instead inquire more about her condition next time.”

In the above-described example, the system may store information reflecting that it is to avoid describing it has a friend with similar experiences. The guardrail observers described herein may, for example, reject a message from an outside LLM if it responds with an imaginary friend. The guardrail observers may respond with an adjusted message noting that the outside LLM is to not imagine a friend but instead merely inquire about the user's condition. The guardrail observers may analyze a subsequent received response from the outside LLM, and if it is appropriate to send, then send to the user. In this way, the guardrail observers may effectuate the domain expert's preferences.

Thus, as one example, mentor mode may cause an update of information used by the guardrail observers. For example, a domain expert (e.g., health professional) may identify an additional goal for a user. In this example, the system 100 interacting with the domain expert may store data identifying the additional goal. As an example, the goal may be stored as being associated with the planner described in FIG. 1C. In some embodiments, the goal may be included in a prompt which informs the planner (e.g., the associated LLM) its intended purpose and identifies goals associated with the user. In some embodiments, the goal may be stored as data in a database which is accessible to the planner.

### Stimulating Attention and Engagement

Even if properly curated replies are generated by the empathetic dialogue generation system 100, if a user 108 is not engaged or aware of the replies (either due to the user's 108 attention being elsewhere or a cognitive condition) the user 108 may not benefit from conversation with the system 100. Ensuring a user 108 is engaged in conversation can involve an LLM identifying language suggestive of lack of engagement and identifying periods of time lacking user 108 interaction.

The system 100 can provide user prompts 112 to the LLM system 120 with system prompts to identify if a user 108 is engaged in conversation or not. Such a system prompt can precede a user prompt 112 or can modify the user prompt 112. For example, a system prompt can be “Analyze the following messages and identify if the user appears engaged.” The system 100 can also direct one or more guardrail observers to review contents of the dialogue history database to identify trends in conversation which suggest engagement or lack of engagement. Such a system prompt can be “Review the previous [user-selectable threshold number or pre-configured number of] messages and identify if the user is engaged in the conversation or not.”

The empathetic dialogue generation system 100 can also include access to a timer, either internally included or included within the world knowledge database. By referencing the timer, the system 100 can determine when a user 108 has not responded to replies in a time sufficient to suggest engagement implying disinterest. For example, the system 100 can be configured to determine a user 108 is disinterested after a period of five minutes without a new message 118 from a user 108. In this example, a user 108 can be engaging with the system 100 regularly but then not provide a new message 118 for a period of five minutes, after which the system 100 will determine that the user 108 is disinterested and will take action to address the disinterest. In some embodiments, a duration of time corresponding to detected disinterest in a user 108 can be between thirty seconds and five minutes.

Once the system 100 determines that a user 108 is disinterested, the system 100 can generate or retrieve an image and/or video to present to the user 108 to induce the user 108 to become more aware of conversation with the system 100. Generating an image may include providing a text description 208 to a generative model which can generate a corresponding image, searching through the world context 132 for relevant images, or searching through an avatar image database for relevant images. Generating a video may involve searching through one or more pre-made videos held within a database.

Once the system 100 displays a video or image for the user 108, the system 100 can wait an additional amount of time before either providing another video or image or continuing to wait for the user 108 to initiate interaction with the system 100 by sending a new message 118.

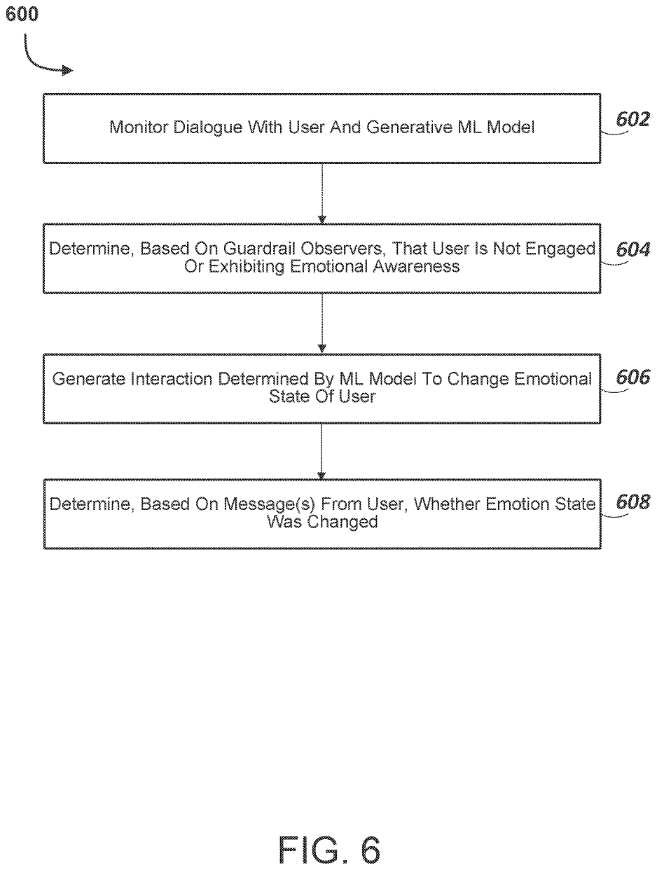

FIG. 6 is a block diagram illustrating an example embodiment of process 600 for monitoring and responding to a user's 108 level of engagement. The process 600 may be performed, for example, by the system 100.

The process 600 can begin at step 602 by monitoring dialogue between the user 108 and the system, wherein monitoring the dialogue includes instructing one or more of the guardrail observers to review the dialogue history database and prepare a report on the user's 108 likely level of engagement. At step 604, if the method determines that the user 108 is not engaged—such as by receiving an adjustment from the guardrail observers which indicates that the user 108 is not engaged—the method can proceed to step 606 by engaging with the LLM system 120 (which may be an LMM) to generate an interaction (an audible or text reply, an image, or a video) determined to cause the user 108 to engage with the system.

The system can, for example, retrieve a summary of the user 108 by sending a system prompt to the guardrail observers, receiving an adjustment, and then sending a second system prompt with the adjustment to the LMM including a command to generate a corresponding interaction. A format which the interaction takes may depend on which medium of communication was previously being used. If the system 100 was using audible or text replies to interact with the user, step 606 can include a modal switch in which the system 100 can begin to use videos or images to interact with the user. Similarly, if the system 100 previously used images and videos to interact with the user, step 606 can include a modal switch to using audible or text replies.

The interaction can then be provided to the user 108. In some embodiments, the interaction may be provided to the guardrail observers for analysis (e.g., to identify harmful content). Lastly, at step 608, the system can instruct the guardrail observers to analyze messages 118 received after the interaction is provided to identify a user's 108 level of engagement. If the user 108 is still not engaged, the system can repeat the method 600 or go to a silent mode for a pre-configured amount of time or until the user initiates conversation.

### Emotional Awareness

Similar to evaluating user 108 engagement, the system 100 can additionally send system prompts to the guardrail observers 122 or the LLM system 120 to analyze the dialogue history database (and future user prompts 112) to identify a user's 108 mental and/or emotional state. If the system 100 determines that the user 108 has a negative mental state or emotional state, the system 100 can instruct generation of adjustments to accommodate the negative mental or emotional state by generating system prompts to instruct generation of adjustments which are intended to address the negative mental or emotional state. For example, a first system prompt can be “Analyze the last twenty messages 118 to determine if the user 108 is experiencing emotional or mental distress.” If the user 108 is determined to be experiencing a negative mental or emotional state, the system 100 can generate a system prompt of “Generate a reply to the user's 108 message 118 which relieves their negative emotional mental or emotional state”, wherein a corresponding adjustment can be generated.

In some embodiments, the system may offer or otherwise advise the user to seek help from a qualified mental health professional. For example, one of the LLMs which implements the guardrail observers described herein may identify potential harm and generate a direct message to the user or add language, or a prompt, for review by an outside LLM which requests generation of text to seek help from a mental health professional.

### Monitoring Health-Related Dialogue

Along with monitoring user 108 engagement and awareness, the system 100 can monitor user 108 messages 118 to identify patterns suggestive of or directly corresponding to health conditions or descriptions of the user 108. The system can direct the guardrail observers (via application of system prompts) to identify language within each message 118 which suggests or is related to a health condition or state.

For example, a message 118 may be “My head is spinning” and the system may identify that the message 118 likely corresponds to a health condition and can categorize the message 118 within the dialogue history database (by further application of system prompts and the guardrail observers). Categorization of health conditions can involve sending a system prompt to a guardrail observer requesting the guardrail observer place a phrase or message 118 into a pre-defined health category. The pre-defined health categories can include anxiety, attention disorder, depression, blood pressure, temperature, pain, among others.

When accumulating message 118 which correspond to health conditions or states, the system can also categorize the messages 118 for later review by mentors engaging in mentor mode. For example, the previously mentioned message 118 of “My head is spinning” can be categorized as “Condition relating to head.” The system can thus summarize messages 118 into categories for presenting to mentors engaging in the mentor mode. Information categorized in the described method can include timestamps, a record of which calendar date and time a corresponding message 118 was received.

Additionally, along with determining that a message 118 corresponds to one or more health conditions or states, the system can also request and record a degree of certainty corresponding to how much confidence can be assigned to the analysis, wherein the degree of confidence can be in a numerical format between zero and one hundred. In some embodiments, analysis of user 108 message 118 can be performed after each message 118 is received. In some embodiments, analysis of user 108 message 118 can be performed on a periodic basis by analyzing the dialogue history database.

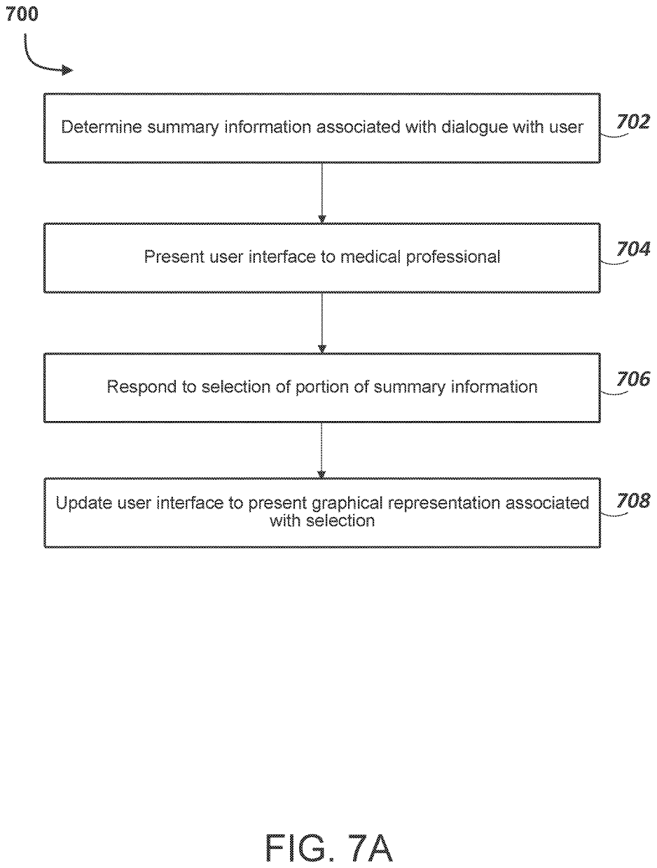

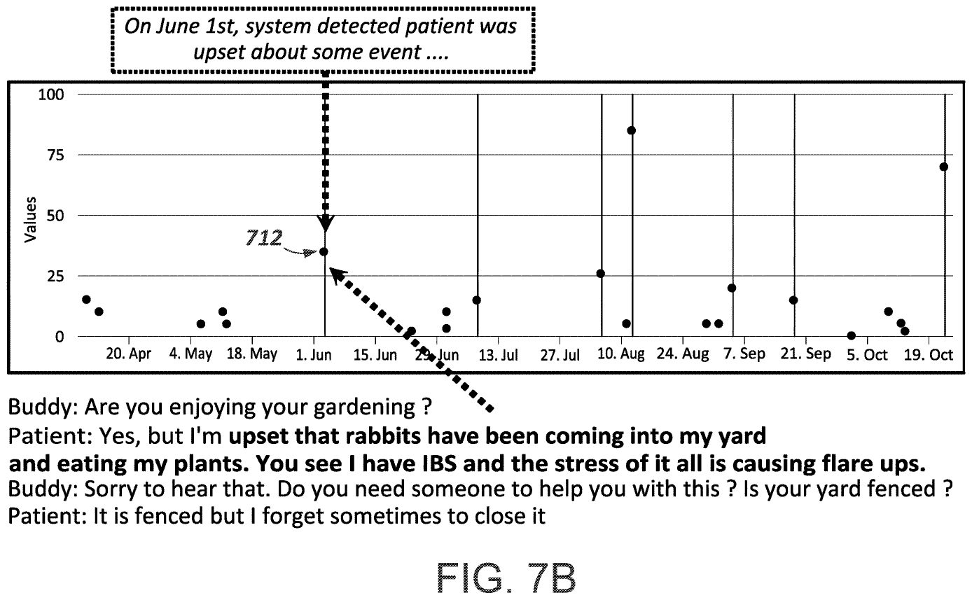

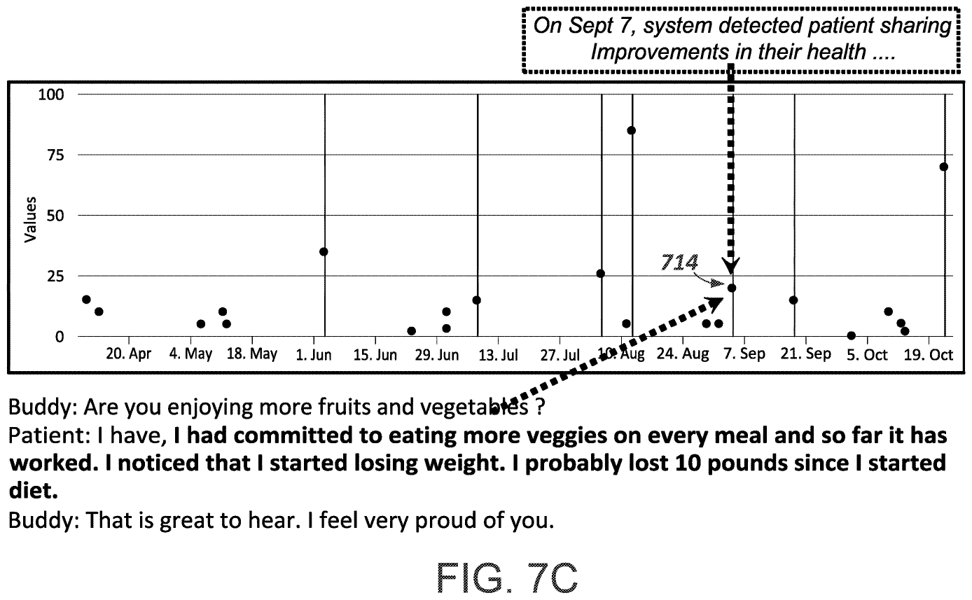

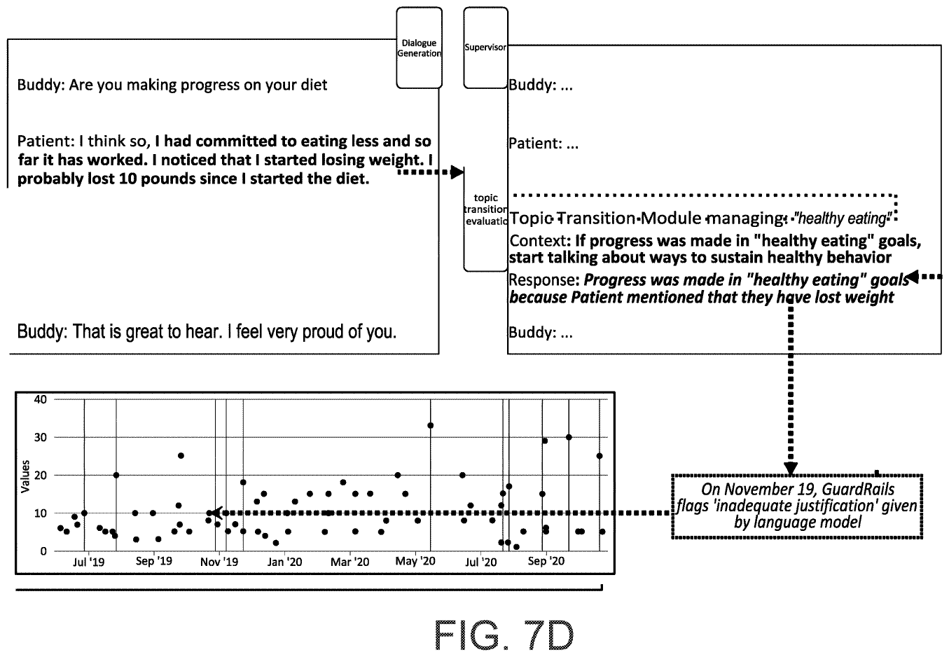

FIG. 7A is a block diagram illustrating an example process 700 of categorizing health related information from user 108 messages 118 and presenting the information to mentors. The process 700 may be performed, for example, by the system 100.

First, at step 702, the system identifies and categorizes health related information within user messages 118. Next, at step 704, after a mentor accesses a user's profile, a user interface will be presented which includes the categorized information in a format which can be read by the mentor. Next, upon receipt of interactions between the mentor and the user interface at step 706, the system, at step 708, can retrieve and display portions of categorized information along with summaries, wherein the summaries can include time stamps and other descriptors of the information.

FIGS. 7B and 7C are example user interfaces that include summarizations of observed message 118 including information relating to health states and/or conditions as displayed within mentor mode.

In FIG. 7B, a series of messages 118 and replies are shown in which the system identified language suggestive of a health condition. In this example, the system has identified language corresponding to having irritable bowel syndrome (“IBS”) and experiencing flare ups of symptoms at 712. The identified language can also be correlated with received health data from a health device, such as illustrated in FIG. 1D, to identify patterns and associations between a user's symptoms and language spoken by the user. As is shown in the accompanying reply, the system didn't respond with health advice. Instead, the health symptoms were identified, assigned a confidence value and a timestamp, and summarized into a category. Upon accessing the mentor mode, the system summarized the health-related conversations and displayed them on a graph for the mentor to view.

FIG. 7C similarly includes identification 714 of a message 118 corresponding to a user 108 altering their eating and experiencing significant weight loss.

FIG. 7D is a user interface describing the system performing topic transition structure analysis during the follow-up step. The system identifies 716 contents of a message 118 suggestive of the user making progress towards achieving one or more goals and can record a notification of the progress in the dialogue history and/or user model 134 databases. During application of the topic transition structure, the system can analyze the user message 118 to determine if progress was made towards achieving a goal, along with a confidence value associated with the analysis. The system can perform cyclical analysis, analyzing text explanations for an analysis to assist determining confidence values. The progress and confidence values can be saved to a database and included as a component of a summary.

The above-described user interfaces may be presented on a user device, for example for use by a health professional.

### Social Determinants of Health

Humans are influenced by their environments, so while a user's 108 preferences and opinions are necessary information when addressing the user's 108 needs and desires, being aware of the user's 108 environment can enable prediction of services which may be beneficial to the user 108. Aspects of a user's 108 environments which may be useful when predicting beneficial services are herein referred to as social determinants of health (“SDOH”).

SDOH can pertain to a user's 108 geographic location, individual context, behavioral context, and health context. A SDOH pertaining to user's 108 geographic location can be based upon a user's 108 address and location of residence, and can include:
Demographics
Housing—single, multi-family, size, year established, price
Businesses and Zoning—commercial, industrial, residential, etc.
Income
Employment and unemployment—age, vocation, salary
Education—highest degree, dropout rate, daycares, and schools in the area
Public and free transportation services—distance, cost
Food Sources—small markets, supermarkets, farmers markets, fresh foods, especially protein, fruit, and vegetables
Healthcare services—hospitals, clinics, labs, pharmacies, skilled nursing, physical therapy
Green space/walkability/recreation
Community centers and religious centers
Crime
Water and Air Quality
Climate (throughout the year)
Political environment—local, county, state

SDOH pertaining to user's 108 individual context relate to general customizable facts, which can include:
Gender identity
Race, ethnicity
Language
Employment—vocation, employment status
Partner, Family
Friends
Social class, groups, status
Hobbies, interests, entertainment
Pets
SDOH pertaining to user's 108 behavioral context relate to information which describes how the user 108 spends their time and on what activities, which can include:
Job/Work
Meals and Nutrition
Sleep
Exercise

SDOH pertaining to a user's 108 health context relate to information describing a user's 108 physical and mental health condition(s) and biosensor readings, which can include:
Disabilities—physical or mental
Chronic conditions—physical or mental
Post-acute health conditions—physical or mental
Availability and use of medications and health equipment and supplies
Availability and engagement with caregivers
Social engagement—people, groups—in-person and virtual
Hobbies, interests—in-person and virtual
Meals and Nutrition
Sleep
Exercise and general mobility

The system 100 can determine a user's 108 SDOH by engaging in conversation with a user 108 and—through instructing the guardrail observers 122 to do so—identifying words or phrases which correspond to relevant topics. After identifying one or more factors indicative of SDOH, the system 100 can generate replies which encourage the user 108 to seek assistance to alleviate issues commonly associated with negative SDOH. For example, the system 100 can determine a user 108 lives in an area with poor accessibility of fresh foods. In this example, the system 100, in response to the determination, can generate a reply which states “Have you considered ordering groceries for home delivery? Also, stocking up on nutritious frozen fruits and vegetables can be easier than shopping frequently for fresh foods.” In another example, the system 100 can determine that a user 108 receives a likely sub-optimal amount of sleep each night and in response can generate a reply which states “If you're feeling tired, sometimes it can be helpful to take a nap. Getting enough rest is important for physical and mental well-being.”

Determining SDOH can be done by generating one or more system prompts to instruct the guardrail observers 122 to analyze each user prompt 112 so as to identify relevant information. If found, the relevant information concerning the SDOH can be recorded in the user model 134.

In alternative embodiments, SDOH can be identified by comparing user prompts 112 against a set of words and phrases pre-associated with certain SDOH. For example, if the word “hungry” is identified as being common in user prompts 112, the system 100 can determine that the user 108 is likely suffering from food insecurity and can record the information in the user model 134 database.

### Other Embodiments

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a multitude of microprocessors, one or more microprocessors in conjunction with a DSP core, or any other such configuration 136. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user 108 input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

1. A method implemented by a system of one or more computers, the method comprising:
accessing a message which forms part of a conversation history with an end-user, wherein the system maintains communications between the end-user and an outside large language model (LLM) being executed by an outside system,
wherein the conversation history reflects messages being provided between the end-user and the outside LLM, and wherein the message was received from the end-user for routing to the outside LLM;
determining an adjustment to the message based on a plurality of guardrail observers, wherein individual guardrail observers reflect individual LLMs which are executed by the system, wherein the guardrail observers adjust messages based on individual conversational characteristics,
and wherein a first guardrail observer adjusts messages based on an individual conversational characteristic that identifies segues in which the first guardrail observer can identify a particular goal set by a domain expert associated with the end-user;
obtaining a response from the outside LLM based on the adjusted message, wherein the response is output via an avatar presented on a user device of the end user.

2. The method of claim 1, wherein each of the guardrail observers accesses one or more databases of a set of databases, and wherein the databases include a dialogue history with the end-user, world context information, a user model, and configuration information.

3. The method of claim 2, wherein the dialogue history reflects a plurality of conversations between the system and the end-user.

4. The method of claim 2, wherein the world context information reflects information obtained by the system via network calls to outside systems, and wherein the system is configured to update the world context information based on a request of the end-user or based on one or more messages included in the conversation history.

5. The method of claim 2, wherein the user model includes information describing the end-user's physical and/or mental health conditions.

6. The method of claim 2, wherein the user model includes information describing social determinants of health.

7. The method of claim 2, wherein the user model includes a plurality of goals set by the domain expert.

8. The method of claim 2, wherein the configuration information includes personalizations associated with the system which are specific to the end-user.

9. The method of claim 1, wherein a second guardrail observer monitors for harmful content.

10. The method of claim 9, wherein the second guardrail observer is configured to adjust a message to remove harmful content.

11. The method of claim 9, wherein the second guardrail observer is configured to adjust a message to instruct the outside LLM to remove harmful content.

12. The method of claim 1, wherein a third guardrail observer is configured to adjust a message to include contextual information relevant to the end-user.

13. The method of claim 12, wherein the contextual information includes information relevant to personal details associated with the end-user.

14. The method of claim 1, determining an adjustment comprises:
obtaining output from the plurality of guardrail observers, wherein individual output reflects adjustments to the message; and
selecting a particular output from the plurality of guardrail observers, wherein the selection is based on priority information associated with the guardrail observers.

15. The method of claim 1, wherein obtaining the response from the outside LLM comprises:
analyzing the response via the guardrail observers; and
adjusting the response prior to output via the avatar.

16. The method of claim 15, wherein adjusting the response comprises generating information for transmission to the outside LLM which causes adjustment of the response via the outside LLM.

17. The method of claim 15, wherein adjusting the response comprises adjusting, via one or more of the guardrail observers, the response.

18. The method of claim 1, further comprising:
causing presentation, via a user device associated with the domain expert, of an interactive user interface, wherein the interactive user interface:
responds to messages with the domain expert which are associated with the end-user, and
receives updates to one or more of the guardrail observers for use in conversing with the end-user.

19. The method of claim 18, wherein the system is configured to search for a specific scenario in the conversation history with the end-user, and wherein the system is configured to update the guardrail observers for the specific scenario.

20. The method of claim 18, wherein the interactive user interface is configured to present summary information associated with the conversation history with the end-user.

21. The method of claim 1, wherein the system is configured to present an infographic to the end-user, and wherein the infographic is presented based on information describing its relevance by the domain expert.

22. The method of claim 1, wherein the avatar is selectable by the end-user.

23. The method of claim 1, wherein the domain expert is a health professional or an education professional.

24. A system comprising one or more processors and non-transitory storage media storing instructions that when executed by the one or more processors, cause the one or more processors to:
access a message which forms part of a conversation history with an end-user, wherein the system maintains communications between the end-user and an outside large language model (LLM) being executed by an outside system,
wherein the conversation history reflects messages being provided between the end-user and the outside LLM, and wherein the message was received from the end-user for routing to the outside LLM;
determine an adjustment to the message based on a plurality of guardrail observers, wherein individual guardrail observers reflect individual LLMs which are executed by the system, wherein the guardrail observers adjust messages based on individual conversational characteristics,
and wherein a first guardrail observer adjusts messages based on an individual conversational characteristic that identifies segues in which the first guardrail observer can identify a particular goal set by a domain expert associated with the end-user; and
obtain a response from the outside LLM based on the adjusted message, wherein the response is output via an avatar presented on a user device of the end user.

25. Non-transitory computer storage media storing instructions that when executed by one or more processors, cause the one or more processors to:
access a message which forms part of a conversation history with an end-user, wherein the system maintains communications between the end-user and an outside large language model (LLM) being executed by an outside system,
wherein the conversation history reflects messages being provided between the end-user and the outside LLM, and wherein the message was received from the end-user for routing to the outside LLM;
determine an adjustment to the message based on a plurality of guardrail observers, wherein individual guardrail observers reflect individual LLMs which are executed by the system, wherein the guardrail observers adjust messages based on individual conversational characteristics,
and wherein a first guardrail observer adjusts messages based on an individual conversational characteristic that identifies segues in which the first guardrail observer can identify a particular goal set by a domain expert associated with the end-user; and
obtain a response from the outside LLM based on the adjusted message, wherein the response is output via an avatar presented on a user device of the end user.

26. (canceled)

27. (canceled)

28. (canceled)

29. (canceled)
